(19) United States
(12) Patent Application Publication
(10) Pub. No.: US 2008/0173067 A1
(43) Pub. Date: Jul. 24, 2008

(54) Automated nasal spray pump testing

(76) Inventors: Dino J. Farina, Holliston, MA (US); Timothy M. Fallon, N. Falmouth, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/983,806

(22) Filed: Nov. 9, 2007

Related U.S. Application Data
(60) Provisional application No. 60/858,257, filed on Nov. 10, 2006.

(51) Int. Cl. G01F 25/00

(52) U.S. Cl. 73/1.16

(57) ABSTRACT

An automated system for testing a spray pump assembly includes a system computer, a robotic handler, holder tray, actuator, and analytical balance. The system computer issues commands to the robotic handler to handle and to transport spray pump assemblies, collection vessels, waste collectors, and nozzle tip dabbers. The robotic handler includes an electromechanical gripper capable of handling objects of varying sizes and sensing contact between gripped objects and another object. The robotic handler may also perform shaking functions. The holder tray, actuator, and other system elements may include sensors for detecting the presence of testing objects. The spray pump assembly may include a collet with a tapered and threaded aperture for securing the collet to a spray pump. The system may further include an elevator assembly for positioning and transporting the actuator (while holding a spray pump assembly) between a first testing area and a second testing area.

### RELATED APPLICATION

This application claims the benefit of U.S. Provisional Application No. 60/858,257, filed on Nov. 10, 2006. The entire teachings of the above application are incorporated herein by reference.

### BACKGROUND

The U.S. Food and Drug Administration (FDA) has developed a set of industry guidelines for applicants (e.g., pharmaceutical companies) who are planning product quality studies to measure bioavailability (BA) and establish bioequivalence (BE) in support of new drug applications (NDA) or abbreviated new drug applications (ANDA) for locally acting nasal sprays using metered-dose spray pumps. These guidelines include specific recommendations for BA and BE studies of prescription corticosteroids, antihistamines, anticholinergic drug products, and the over-the-counter (OTC) mast-cell stabilizer cromolyn sodium. The recommendations include seven tests and associated metrics and lifestages shown in Table 1, all of which should be conducted using validated analytical methods to characterize the in vitro performance of the products.

TABLE 1
FDA recommended BA & BE tests and metrics.

| Test Name | BA & BE Metric(s) | Lifestage(s) |
|---|---|---|
| 1. Single Actuation | Drug mass per single | Beginning of |
| Content Through | actuation or dose | Life (BOL), |
| Container Life | | End of Life |
| | | (EOL) |
| 2. Droplet Size | D₁₀, D₅₀, D₉₀, | BOL, EOL |
| Distribution by | span @ 2 distances | |
| Laser Diffraction | | |
| 3. Drug in Small | Drug mass below upper | BOL |
| Particles/Droplets | stage | |
| by Cascade Impaction | | |
| 4. Drug Particle | Drug CMD; extent of | BOL |
| Size Distribution | agglomerates | |
| by Microscopy | | |
| 5. Spray Pattern | Area, Ovality ratio | BOL |
| | @ 2 distances | |
| 6. Plume Geometry | Height, width, and cone | BOL |
| | angle of 1 side view at | |
| | 1 delay time | |
| 7. Priming and | Drug mass per single | Priming: BOL |
| Re-priming | actuation or dose at | Re-priming: |
| | first primed or re-primed | not specified |
| | actuation | |

The Beginning of Life (BOL) lifestage is defined as the first actuation (s) following the labeled number of priming actuations. The End of Life (EOL) lifestage is defined as the actuation (s) corresponding to the label claimed number of actuations.

The FDA recommends using automated actuation systems when conducting the tests listed in Table 1, to decrease variability in drug delivery due to operator factors and, thus, increase the sensitivity for detecting potential differences between products. The FDA also recommends that the automated actuation system includes settings for force, velocity, acceleration, stroke length, and other relevant parameters. The FDA further recommends that the selection of appropriate settings used with the automated actuation system be relevant to proper usage of the product by the trained patient. The settings may be available from pump suppliers or by conducting an exploratory study in which the relevant parameters are varied to simulate in vitro performance upon hand actuation.

With regard to Tests 1 and 7 in Table 1, the FDA specifically recommends determining the delivered (e.g., emitted or ex-actuator) drug mass from the units. In conjunction with these FDA recommendations, the United States Pharmacopoeia (USP) provides specific test methods that should be followed for testing the delivered dose uniformity of nasal spray products, including the use of an automated actuation system. Both the FDA and USP recommendations state that the nasal spray product to be tested should be prepared as directed on the label and instructions for use, which invariably implies shaking and priming the product. Though not stated directly in either the FDA or the USP recommendations, measuring the delivered shot weight (e.g., the weight of the delivered spray) is often used as the primary indicator of pump delivery performance and as a supplemental measurement for delivered dose uniformity. Overall, these recommendations pose many challenges to organizations involved in testing nasal sprays, including:
1. How to determine the proper settings for the automated actuation system employed to conduct the in vitro tests;
2. How to develop the labeling instructions for use with the product so that the in vitro testing can actually be accomplished (the label may include (a) instructions for shaking, (b) instructions for priming and re-priming, and (c) the number of rated doses in the container);
3. How to develop and validate the test method(s) used to collect and analyze the test data and ensure high product quality;
4. How to validate the system(s) used to execute the test methods and store the results; and
5. How to integrate these tasks in a way that satisfies the above mentioned regulatory recommendations while minimizing the time and resources it takes to have products gain initial or continued approval for sale in the United States.

The currently accepted method for performing spray content uniformity testing relies heavily on manual operations for actuation, sample weighing, shaking, data collection, and data analysis. Some companies employ a completely manual method with paper records, while other companies use a combination of automated actuation and manual sample collection with some electronic record keeping.

Regardless of the method employed, manual operations related to actuation, sample collection, and/or weighing are known to be fraught with problems such as human error, production inefficiencies, operator repetitive stress, and low data integrity. Additionally, paper records create a significant 21 CFR Part 11 (requirements related to electronic records and signatures) compliance challenge in today's pharmaceutical environment. These problems lead to production bottlenecks and are likely to cause additional testing due to current Good Manufacturing Practices (cGMP) requirements when data discrepancies appear, both of which may seriously affect the manufacturer's profitability. Some processes, however, are best handled manually. For instance, manually moving a sample or samples of collected doses to an automated sample preparation system may be perfectly acceptable because the sample preparation system may be a shared resource in a separate laboratory.

### SUMMARY

According to one embodiment, an automated system for testing a spray pump assembly includes a robotic handler, a tray for holding multiple spray pump assemblies and collectors, a spray pump assembly actuator, and a weighing device such as a balance. The robotic handler transports the spray pump assemblies and collectors between the tray, the spray pump assembly actuator, and the balance to facilitate automated testing of spray pump assemblies. The testing may include performing shot weight and spray content uniformity tests. The tray may include sensors associated with each spray pump assembly and collector to sense the presence of each spray pump assembly and collector. A system computer may use the sensor information to assist a user in loading the tray and to ensure proper operation of the system.

In one embodiment, the robotic handler includes an electromechanical gripper. The electromechanical gripper may include a rotary motor, a left- and right-handed linear screw, and first and second gripper elements. The first and second gripper elements are movably coupled to respective left- and right-handed portions of the linear screw. The linear screw, in turn, is coupled to the rotary motor. When a system controller sends control signals to the rotary motor, the rotary motor drives the linear screw-rail assembly to move the first and second gripper elements in opposite linear directions.

The first and second gripper elements include jaws to grasp objects (e.g., a spray device assembly) when the gripper elements are driven together or to release objects when the gripper elements are driven apart. The gripper elements may include movable jaws and sensors to sense movement of the jaws, for example, when the robotic handler moves an object held by the jaws towards a stationary object the robotic handler continues move in the same direction after the object makes contact with the stationary object.

The spray pump assembly may include a spray pump clamp which the robotic handler or actuator may more easily handle. The clamp may include a threaded aperture centered about a central axis of the clamp with a first diameter at a bottom side of the clamp and a second diameter at a top side of the clamp. The clamp may be secured to a nozzle tip of the spray pump by simultaneously inserting the nozzle tip into the aperture of the clamp and rotating the clamp until the clamp is secured to the nozzle tip.

The system may further include a nozzle tip dabber which the robotic handler may use to keep the nozzle tip of the spray pump clean. In one embodiment, the nozzle tip dabber includes a base, an absorbent pad, and a flexible pad. The flexible pad is attached to the base and the absorbent pad is attached to the flexible pad. The flexible pad improves the cleaning capabilities of the absorbent pad.

In another embodiment of an automated system for testing a spray pump assembly, the system includes a first testing region with a first testing device, a second testing region with a second testing device, an elevator assembly connecting the first and second testing regions, and a spray pump assembly actuator attached to the elevator assembly. The elevator assembly may move the actuator between the first and second testing regions to automate performing multiple tests on spray pump assemblies. The first testing region of the system may employ a robotic handler for handling and transporting spray pump assemblies. In one example embodiment, the first testing device is an analytical balance and the second testing device includes either (i) a camera and a first laser configured to measure spray pattern, or (ii) a second laser and a receiver configured to measure droplet size distribution through laser diffraction, or both.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a front view of an automated spray pump testing system for dose content uniformity (DCU) and pump delivery testing according to one embodiment;

FIG. 2A is a front view of the testing area of the testing system of FIG. 1;

FIG. 2B is a top view of the testing area of FIG. 2A;

FIG. 2C is a block diagram of the automated spray pump testing system illustrating example system elements;

FIG. 3 is a perspective view of the testing area illustrating an actuator, balance, and tip dabber assembly according to one embodiment;

FIGS. 4A-4C are flow diagrams of example processes of testing a spray pump device;

FIGS. 5A-5C are perspective views of an actuator according to one embodiment;

FIG. 6 is a flow diagram of an example process of securing a spray pump device in an actuator;

FIGS. 7A-7B are perspective views of a robotic device according to one embodiment;

FIG. 8 is a flow diagram of an example process of controlling a robotic handler based on feedback from sensors in the movable jaws of the electromechanical gripper;

FIG. 9 is a cross-sectional view of an example nozzle tip dabber according to one embodiment;

FIGS. 10-11 are flow diagrams of example processes for testing a spray pump device illustrating use of the nozzle tip dabber;

FIG. 12A is a perspective view of a fully loaded holder tray according to one embodiment;

FIG. 12B is a side view of the holder tray of FIG. 12A illustrating a holder tray sensor system according to one embodiment;

FIG. 13 is a flow diagram of an example process illustrating use of the holder tray sensor system of FIG. 12B;

FIGS. 14A-14B are perspective cross-sectional views of spray pump collection assemblies according to one embodiment;

FIG. 15 is a front view of an embodiment of an automated spray pump testing system for DCU, pump delivery, spray pattern, and droplet size distribution testing;

FIG. 16A is a perspective view of the optical measurement volume and the optical device spray pattern and droplet size distribution testing assemblies;

FIG. 16B is a perspective view of the extension volume of FIG. 16A illustrating spray pattern testing;

FIG. 16C is a perspective view of extension volume of FIG. 16A illustrating droplet size distribution testing; and

FIG. 17 is a flow diagram of a process of testing a spray pump device using the automated spray pump testing system of FIG. 15.

### DETAILED DESCRIPTION

A description of example embodiments of the invention follows.

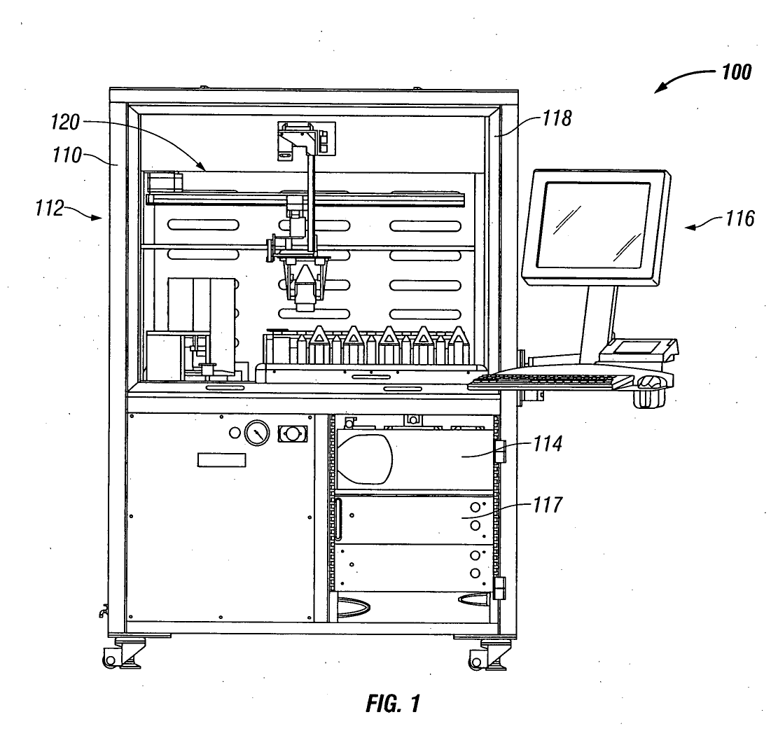

FIG. 1 is a front view of an automated spray pump testing system 100 for automatically performing high throughput dose content uniformity (DCU) and pump delivery testing of spray pump or aerosol devices, such as nasal spray pump bottles, according to one embodiment. The system 100 may also automatically perform priming or re-priming testing and investigate various shaking methods for a spray product that a user is developing. As described above, manual techniques for testing spray pump devices are tedious, time-consuming, and error-prone in production environments. The automated spray pump testing system 100, however, significantly reduces the “time to approval” for organizations involved in spray pump or aerosol drug product testing.

As described in more detail below, embodiments of the automated spray pump testing system 100 may incorporate the example features and benefits set forth in Table 2.

TABLE 2
Features and Benefits of Embodiments of the System 100

| Features | Benefits |
|---|---|
| 1) Meets product cost and | Keeps customer production on schedule |
| delivery constraints | and on budget |
| 2) Provides high data | Improves testing efficiency, lowers |
| integrity with reduced | testing costs, and reduces time to |
| testing time | market |
| | Reduces testing due to human errors |
| | related to fatigue and repetitive stress |
| 3) Available in various | Dedicated system for device-specific |
| device formats (e.g., | high performance |
| vertically actuated or | |
| side actuated) format | |
| 4) Provides highly | Minimizes operator intervention |
| automated operation | Frees laboratory personnel to perform |
| | other duties |
| | Improves testing efficiency and |
| | throughput |
| 5) Provides easy | Lowers total cost of ownership for |
| serviceability with | the System with high availability |
| high uptime | |
| 6) Built-in validation | Streamlines integration into |
| strategy based on industry | pharmaceutical testing environments |
| standards (e.g., GAMP 4) | Assists with compliance with industry |
| | standards |
| 7) Individually shakes | Establishes a repeatable method for |
| devices prior to and | shaking the product based on pump |
| during testing | delivery and dose content uniformity |
| | performance |
| | Demonstrates the sensitivity of |
| | shaking on the product's viscosity, |
| | dose content uniformity, and other |
| | physical properties |
| 8) Measures shot weight | Complies with industry standards for |
| with high resolution | analytical weighing (e.g., USP <41>) |
| (e.g., 0.1 mg) | |
| 9) Collects and weighs | Complies with industry standards for |
| individual sprays for | delivered dose uniformity testing |
| chemical assaying | (e.g., USP <601>) |
| 10) Collects reasonable | Reduces operator intervention and |
| amounts of formulations | improves testing efficiency |
| from multiple devices | Meets typical production run testing |
| in one run | regimes |
| 11) Built on a secure | Enables compliance with 21 CFR Part 11 |
| database software | Enables consolidated views of device |
| platform | actuation history, including audit |
| | trails |
| | Provides flexibility to create, edit, |
| | and execute validated test methods, |
| | including full actuation event |
| | definitions for each device |
| 12) Runs programmable | Simplifies operation and ensures high |
| methods to automate tasks | reproducibility. |
| 13) Provides built-in | Allows compliance with occupational |
| odor removal filtration | safety regulations for the handling of |
| | odorous products |
| 14) Standalone System | Improves serviceability and uptime |
| design with only | Reduces effects of vibrations on weighing |
| electrical inputs | performance |
| | Reduces facilities requirements |

As indicated in Table 2, embodiments of the automated spray pump testing system 100 are stand-alone systems with electrical and computer network interfaces. Standalone systems provide various benefits including superior vibration isolation for faster weighing performance; simpler installation and supervision of operation; independence from laboratory variables such as bench space and availability, air currents, and fume exhaust; and integration of proven technologies.

The system 100 may include a unified steel frame 110 to provide simplified construction and vibration isolation for the system's testing and measurement devices. The elements of the system 100 include a testing area 112, a system computer 114, system controller 117, and Input/Output (I/O) devices 116 through which a user may interact with the system 100. As illustrated in FIG. 1, the testing area 112 may be positioned at a height that is easily accessible to a user (e.g., easily accessible to a user that is sitting or standing). The integrated system computer 114 and system controller 117 simplify cable routing, assembly, and service.

The testing area 112 of the system 100 includes a robotic device handler 120 that safely and reliably handles and transports devices and collectors within the testing area 112. In this embodiment, the robotic device handler 120 is an intelligent four-axis design that is able to handle spray devices of varying shapes and sizes. According to this embodiment, the robotic device handler 120 may be programmed to perform shaking and intra-actuation nozzle tip dabbing or cleaning of the spray devices. The robotic device handler 120 provides highly automated operation. The system 100 may operate without user intervention except for loading and unloading devices and samples, and for handling error conditions (e.g., network unavailability, mishandling of device or collection vessel, lack of airflow). Also, the system 100 may run uninterrupted over a period of time consistent with pharmaceutical production equipment available today, without routine maintenance other than cleaning.

The testing area 112 is enclosed within the steel frame 110 and sliding glass access doors 118. The sliding glass access doors 118 provide an operator an interface to the testing area 112 for loading or unloading spray device samples. The sliding glass access doors 118 may include tempered glass panels to reduce the effects of static charge buildup on the system's testing and measurement devices and to provide adequate operator safety.

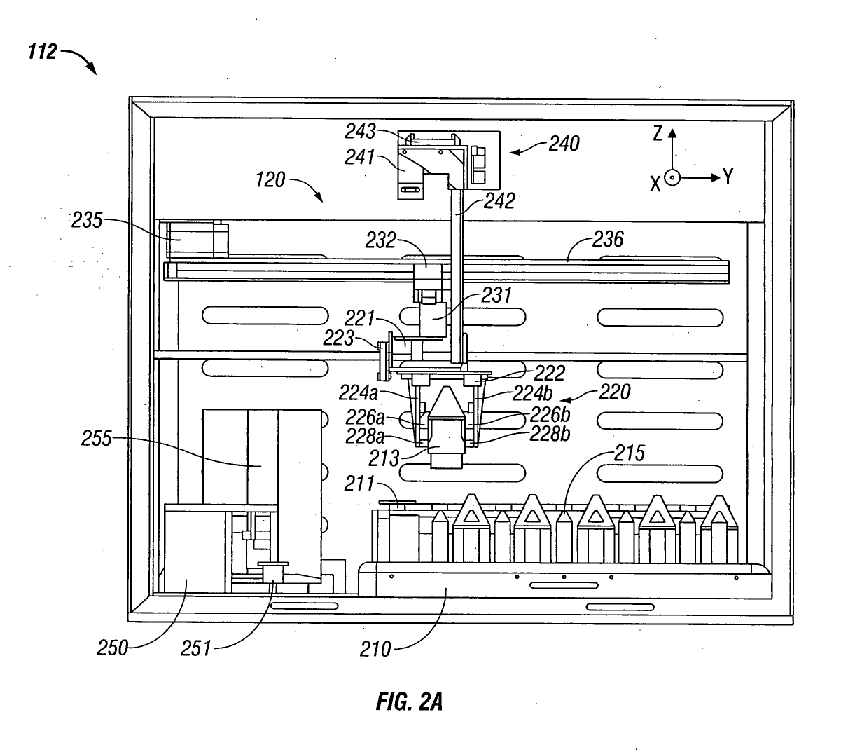

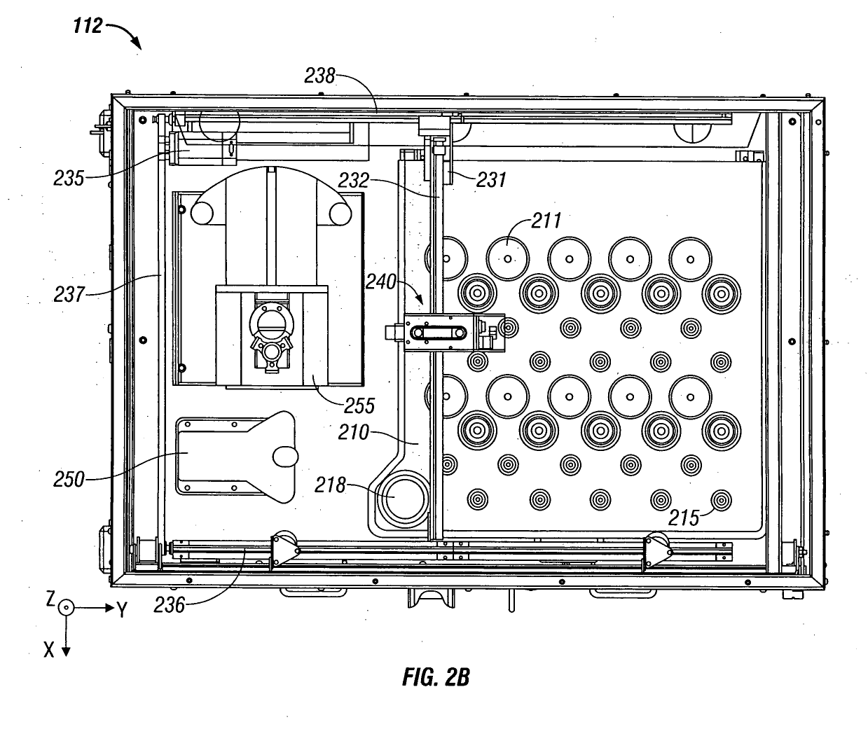

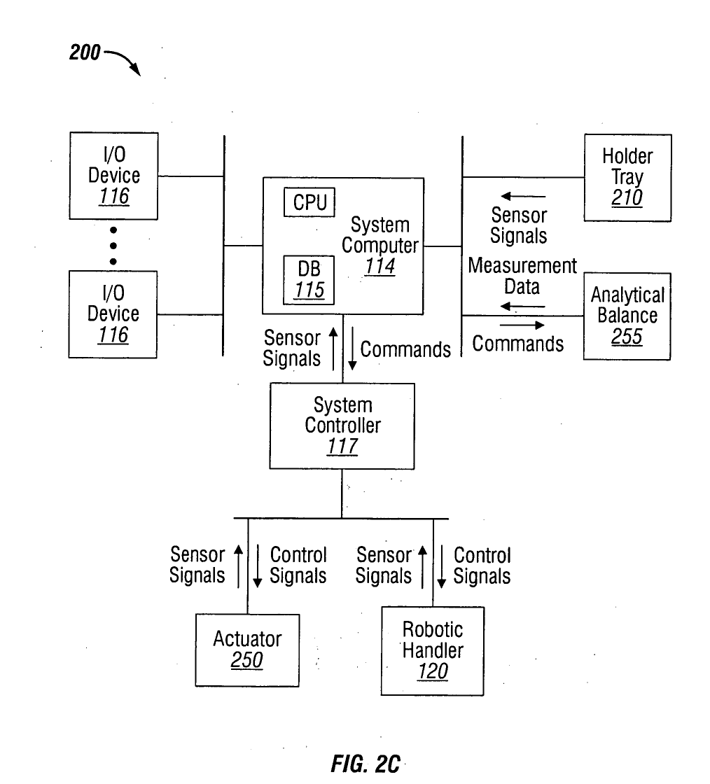

FIG. 2A is a front view of the testing area 112 of FIG. 1, illustrating, in particular, the details of the robotic handler 120. The testing area 112 incorporates the robotic handler 120, a holder tray 210, an actuator 250, and an analytical balance 255. The robotic handler 120 may be commanded to transport spray devices 311, collection vessels 215, and waste collectors 213 to or from the holder tray 210, the actuator 250, and the analytical balance 255. As described in more detail below, the robotic handler 120 is designed to handle spray devices 311, collection vessels 215, and waste collectors 213 of varying shapes and sizes. For example, the robotic handler 120 may work with off-the-shelf pharmaceutical collection vessels, such as plastic test and centrifuge tubes. The robotic handler 120 is further designed and programmed to transport the spray devices 311, collection vessels 215, and waste collectors 213 so that no formulation fluid leaks or is contaminated. For example, in one embodiment, the robotic handler 120 may be designed and programmed to cap the spray devices 311, the collection vessels 215, or the waste collectors 213. In other embodiments, the robotic handler 120 may be designed and programmed to perform chemical analysis sample preparation, including solvent addition, mixing, filtering, etc.

The robotic handler 120 features an electromechanical gripper 220 for grasping and releasing spray devices or collectors. The electromechanical gripper is designed to minimize the amount of moving parts. The electromechanical gripper includes two stiff gripper elements 224a-b or gripper arms with movable jaws 226a-b and stationary jaws 228a-b. The gripper elements 224a-b are movably coupled to a low mass, high performance, linear screw-rail assembly 222. The linear screw-rail assembly 222 includes a half left-handed and half right-handed screw-rail spindle. The linear screw-rail assembly 222, in turn, is coupled to a rotary motor 221 through a drive coupler 223, which includes two pulleys and a drive belt. In this configuration, the rotary motor may drive the linear screw-rail assembly 222 to cause the gripper elements 224a-b to move in opposite directions (either towards or away from each other depending on the rotational direction that the rotary motor 221 drives the linear screw-rail assembly 222).

The electromechanical gripper 220 connects to a vertically-oriented linear screw-rail assembly 242 and a z-axis motor assembly 240. The z-axis of the robotic handler 120 is designed to be large and not to induce vibrations. The vertically-oriented (z-axis) linear screw-rail assembly 242 is movably coupled to an x-axis screw-rail assembly 232. When a rotary motor 241 of the z-axis motor assembly 240 drives the vertically-oriented linear screw-rail assembly 242, the vertically-oriented linear screw-rail assembly 242 together with the electromechanical gripper 220 and z-axis motor assembly 240 move with respect to the x-axis linear screw-rail assembly 232 along a z-axis (relative to the system 100). Another rotary motor 231 is coupled to the x-axis linear screw assembly 232 (see also FIG. 2B) so that when the rotary motor 231 drives the x-axis linear screw assembly 232, the x-axis linear screw assembly 232 causes the vertically-oriented linear screw-rail assembly 242 together with the z-axis motor assembly and the electromechanical gripper 220 to move along the x-axis.

The x-axis linear screw assembly 232, in turn, movably couples to a first y-axis linear screw assembly 236 and a second y-axis linear screw assembly 238 (see FIG. 2B). A y-axis motor 235 drives the first and second y-axis linear screw assemblies 236, 238 through a y-axis drive coupler 237 (see FIG. 2B) to cause the x-axis linear screw assembly 232, together with the assemblies 220, 240, 242 attached to the x-axis linear screw assembly 232, to move along the y-axis. With four-axes of motion (x, y, y′ (the axis of the electromechanical gripper's linear screw-rail assembly 222), and z), the robotic handler may perform a variety of functions in the testing area 112 including a variety of shaking functions, such as orbital and so-called jerk shaking, as described further below.

FIG. 2B is a top view of the testing area 112 of FIG. 2A. FIG. 2B more clearly illustrates the components of the robotic handler 120 which allow for motion in the x-y plane or horizontal plane. The z-axis motor assembly 240, along with the z-axis linear screw assembly 242 and the electromechanical gripper 220 (see FIG. 2A), movably couples to the x-axis linear screw assembly 232. The x-axis linear screw assembly 232, in turn, movably couples to the first and second y-axis linear screw assemblies 236, 238 as described above. The y-axis motor 235 may drive the first and second y-axis linear screw assemblies 236, 238 through drive coupler 237 to cause the x-axis linear screw assembly 232 along with the attached assemblies 220, 240, 242, to move along the y-axis.

As illustrated in FIG. 2B, the holder tray 210 may hold ten spray devices 311, ten corresponding waste collectors 213, two collection vessels 215 for each spray device 311 (for a total of 20 collection vessels 215), and a nozzle tip dabber 218. This embodiment of the holder tray 210 is configured for dose content uniformity testing of ten devices where one collection vessel 215 is for beginning of life measurements and the other collection vessel 215 is for end of life measurements. The holder tray 210 is also configured for pump delivery testing. For pump delivery testing, the collection vessels 215 are replaced with ten additional spray devices 311. Other embodiments of the holder tray 210 may hold spray devices, collection vessels, and waste collectors of varying shapes and sizes.

FIG. 2C is a block diagram of an automated spray pump testing system 200 illustrating example system elements and the interaction among them. The system computer 114 runs programmable methods and issues commands to the system controller 117. The system computer 114 may run approved and development (e.g., unapproved) methods for data collection. Methods may be approvable (promoted from development status) by users with the appropriate privileges. Similarly, an authorized user may retire methods (e.g. prevent the methods from being executed, but retain all of the method's linked data for viewing). The methods may include user definable parameters for actuation profiles, shaking profiles, and the entire actuation event history, including priming, wasting, and weighing. An example method or actuation event profile for a set of 100-shot devices is illustrated in Table 3.

TABLE 3
An Example Actuation Event Profile

| | Actuation | | Weighing | |
|---|---|---|---|---|
| Shot Number | Event Type | Weigh? | Method | Shake? |
| 1-5 | Priming | No | None | Before start |
| 6-7 (BOL) | Collect both | Yes | Delivered | No |
| | actuations into | | Dose | |
| | a single vessel | | | |
| 8-98 | Waste | No | None | No |
| 99-100 (EOL) | Collect both | Yes | Delivered | No |
| | actuations into | | Dose | |
| | a single vessel | | | |

The system controller 117 generates control signals to control the motion of the robotic handler 120 and the actuator 250 based on the commands from the system computer 114 and sensor signals from sensors integrated into the robotic handler 120 and the actuator 250. As described in more detail below, the holder tray 210 may also include sensors for sensing the presence of each spray device 311, waste collector 213, collection vessel 215, and nozzle tip dabber 218. The system computer 117 is configured to receive, process, and display, via an Input/Output (I/O) device 116, measurement data from the analytical balance 255 and sensor signals from the holder tray 210, actuator 250, or robotic handler 120. For example, the system computer 114 may process sensors signals from the holder tray 210 and visually or otherwise present to the user via I/O devices 116 which elements (e.g., spray device, waste collector, collection vessel) need to be inserted and where they should be inserted.

As indicated in Table 2 above, the system 100 may further incorporate an air handling subsystem to minimize the adverse effects of prolonged user exposure to the spray formulations. For example, the air handling subsystem may remove and/or control odors. The air handling subsystem may also use carbon-based filtration and provide sufficient airflow throughout the testing area 112. The air handling subsystem, however, may be designed so that air currents do not detract from the performance of the analytical balance 255.

The system computer 114 may include a database 115 to store measurement data or other system information. In addition, the system computer 114 may run on a secure database software platform in order to comply with 21 CFR Part 11 and other company standards (e.g., actuation system and method) and for consistent data storage and retrieval formats. The software platform may be centered on processing the results from the numerous device actuations or “actuation events”. Actuation events may be linked directly to the devices from which originated (e.g. a unique identifying number such as lot number or manufacturing batch ID), in addition to other information such as who actuated the device, when the actuation occurred, etc. Additionally, unifying the actuation events by device type, lot number, and device identifier may be implemented to simplify data management and analysis and to allow a complete testing actuation history to be formed.

The system software may use a relational database management system as its core records management entity subsystem. With the system software, users can manage the machine- and human-readable data associated with spray drug product testing (e.g. acquire, process, analyze, etc.) thus allowing companies to:
Become compliant (new users) or maintain compliance (existing users) with 21 CFR Part 11 for Electronic Records/Electronic Signatures (“ER/ES”);
Archive and retrieve machine-readable data to and from safe, stable, and secure media such as network storage locations, CD's or DVD's; and
Establish traceability between the human-readable data and the machine-readable data (e.g. “who, what, when, where and why” for all actions) with particular emphasis on establishing the history of all activities undertaken on the data, system(s), and tested products.

The system computer 114 and corresponding system software can properly handling the following example failure events (along with any other critical system events):
1. Absence of a device or collection vessel in the holder tray, balance, gripper, or actuation system;
2. Prolonged AC electrical power loss;
3. Insufficient airflow through the System for proper odor control (should cause a warning event, but not stop System operation);
4. Load cell calibration failure;
5. Network unavailability (if database is deployed on a network server);
6. Database unavailability;
7. User depression of emergency stop button;
8. Safety doors unlocked; and
9. User logon failure.
   In response to system failures, the system computer 114 may automatically generate an audit trail event.

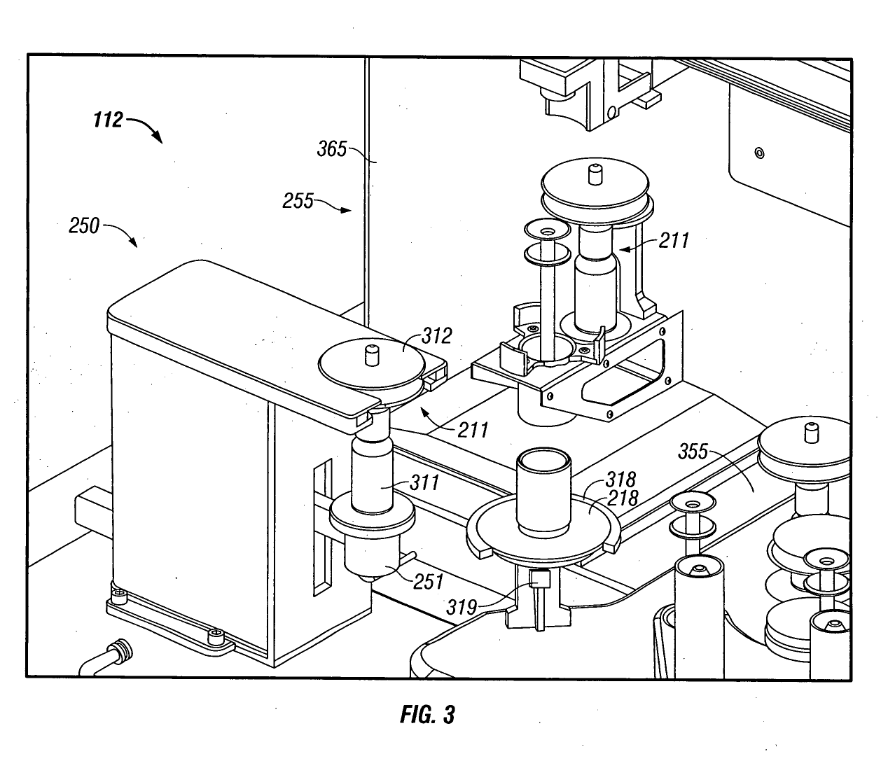

FIG. 3 is a perspective view of the testing area 112 illustrating the actuator 250, balance 255, and nozzle tip dabber assembly (218, 318, 319) according to one embodiment. The actuator 250 holds and actuates the spray device assembly 211, which may include a spray bottle 311 and a collet 312. In this embodiment, the actuator 250 secures the collet 312 so that a force coupler 251 may actuate the spray bottle 311.

The balance 255 or weighing device, is disposed on a granite table 355 which, in turn, is disposed on the metal frame 110 (FIG. 1) through vibration pads. The granite table 355 and vibration pads isolate the balance 255 from vibrations generated by other components of the system (e.g., the actuator 250 or the robotic handler 120) or vibrations generated external from the system 100. Thus, the balance 255 may weigh individual shots in substantial compliance with USP <41>, which requires stable, low vibration mounting for the balance to facilitate rapid and accurate weighing. The balance includes a glass enclosure 356 for preventing air currents and electrostatic forces from affecting weight measurements.

The system 100 may automatically measure the delivered and/or metered dose/shot weight, depending on user programmable inputs, with high resolution (e.g., 0.1 mg). The delivered shot/dose weight is computed as the weight difference of the appropriate collection apparatus (e.g. waste collector or collection vessels) before and after actuation. The metered dose weight is computed as the weight difference of the spray device before and after actuation. Table 4 indicates test measurements, measurement modes and elements for weighing.

TABLE 4
Weighing modes supported by the system.

| Test | Measurement | |
|---|---|---|
| Measurement | Mode | Elements to Weigh |
| Dose Content | Metered | Device |
| Uniformity | Delivered | Sample collection vessel |
| | Metered + | Device + Sample |
| | Delivered | collection vessel |
| Pump Delivery | Metered | Device |
| | Delivered | Waste collector |
| | Metered + | Device + Waste collector |
| | Delivered | |

The analytical balance 255 may be automatically calibrated using two internal calibration weights (providing a minimum of a three point calibration). The automatic calibration procedure may be programmable (e.g. daily, weekly, monthly) and be executed as part of normal operation of the system 100.

The nozzle tip dabber 218 may be stored in a nozzle tip dabber holder 318 that includes a sensor 319 to sense the presence of the nozzle tip dabber 218. As described further below, the nozzle tip dabber 218 is used to maintain a nozzle tip of a spray device free of residue which may affect performance of the spray bottle 311.

Many nasal spray drug products are formulated as thixotropic suspensions and are delivered via a mechanical pump device. A thixotropic material exhibits a decrease in viscosity with increasing applied shear stress or shear rate, followed by a time dependent recovery when the shear load is removed. (Tomato ketchup is a good example of a thixotropic material because it does not start to flow from its container unless sufficient shear is imposed on it, e.g., short stroke, jerk-action shaking motion). The thixotropic nature of nasal spray drug formulations can seriously affect the performance of the emitted sprays. Therefore, to prepare the spray devices properly for actuation and subsequent shot weight measurements, embodiments of the system computer 114 may be programmed to perform various shaking routines with the robotic handler 120.

For certain spray devices, the shaking routine must not tilt the spray devices from a vertical axis, nor impart any foaming into the formulation. Based on a survey of current laboratory practices, and the characteristics of many nasal spray formulations, the shaking routine may operate in either of two modes:
Vertically or diagonally oriented, high acceleration (jerk action) mode for high shear shaking, and
Horizontally oriented, planar (orbital action) mode for gentle shaking.

Both modes may be programmed with various parameters for the shaking routine including amplitude, frequency, and duration. In various embodiments, the shaking routine may be executed prior to or during a test run.

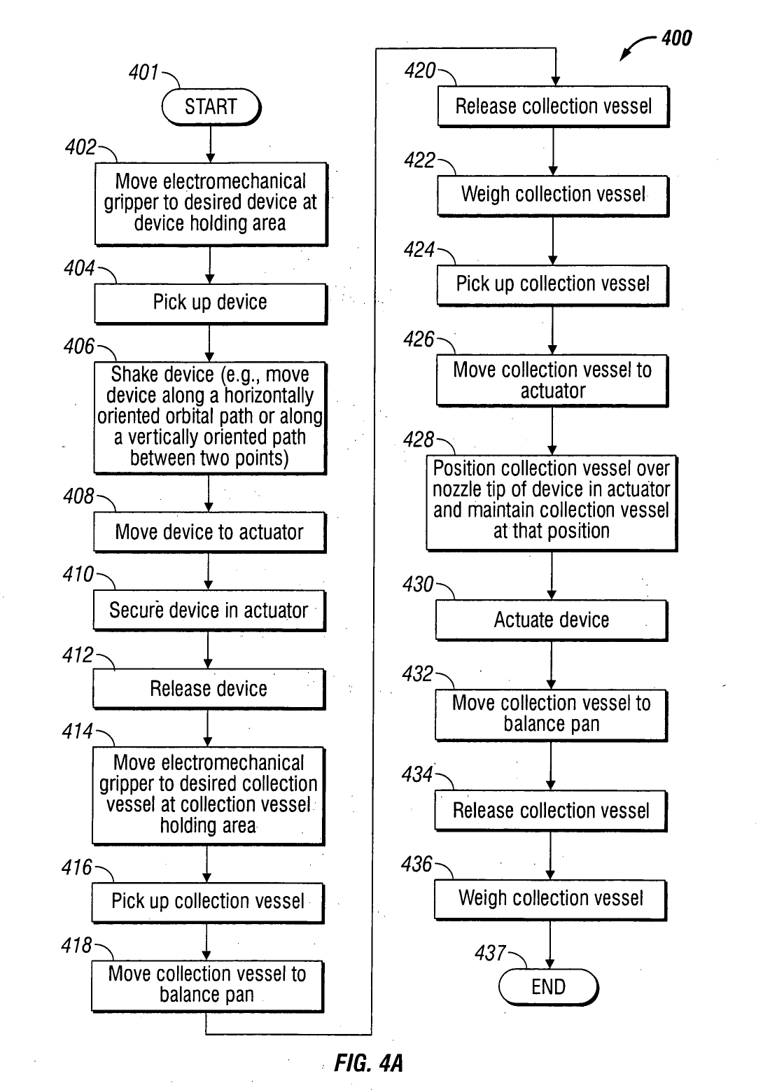

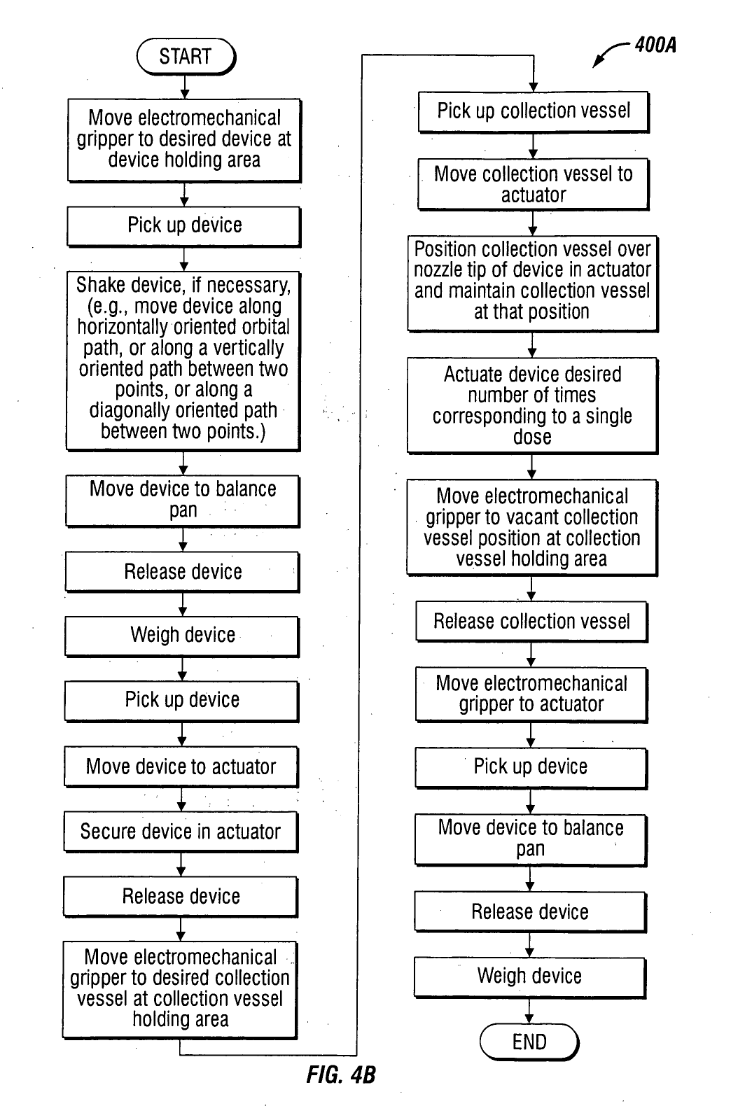

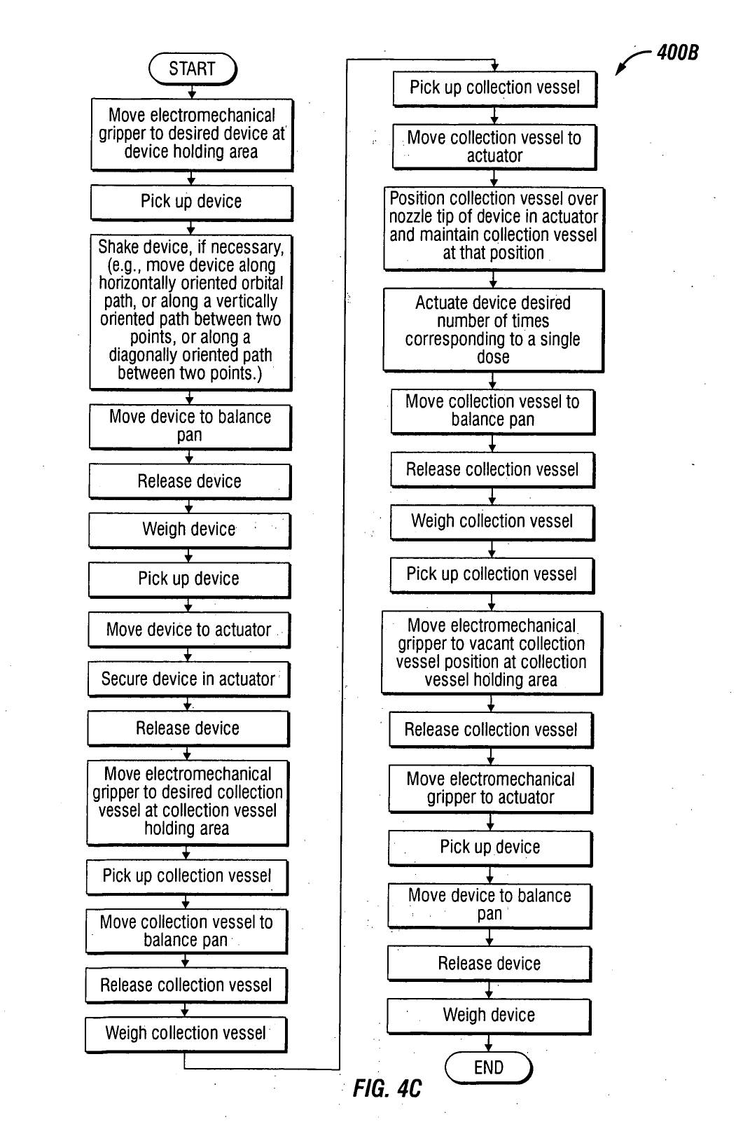

FIG. 4A is a flow diagram of an example process 400 of performing a dose content uniformity test on a spray pump device using the delivered weighing mode (Table 4), and includes an optional shaking routine. After starting 401, a system computer issues commands (via a system controller) to a robotic handler to move the robotic handler to the desired device at a device holding area (e.g., the tray 210). This step involves positioning the electromechanical gripper around the desired device. The system computer then gives commands to the robotic handler to pick up the device 404. Before, while, or after moving the device to the actuator 408, the system computer may give commands to the robotic handler to shake the device 406. For example, the shaking commands may include commands to move the device along a horizontally oriented orbital path or along a vertically oriented path between two points. For the vertically or diagonally oriented path between two points, the robotic handler may be commanded to move the device along the vertically oriented path with high acceleration to simulate a jerking motion by a human. In other embodiments, the robotic handler may be designed to also provide rotational shaking capabilities.

After moving the device to the actuator 408, the system computer gives commands to the robotic handler to secure the device in the actuator 410 and to release the device 412. In steps 414-418, the system computer issues commands to the robotic handler to move the electromechanical gripper to the desired collection vessel at a collection vessel holding area 414, to pick up the collection vessel 416, and to move the collection vessel 418 to a balance pan. After the robotic handler releases the collection vessel 420, the balance weighs the collection vessel 422.

After weighing the collection vessel 422, the robotic handler picks up the collection vessel 424 and moves it to the actuator 426. The robotic handler positions the collection vessel over the nozzle tip of the device in the actuator and maintains the collection vessel at that position 428. In step 430, the system computer issues commands to the actuator to actuate the device for a number of repetitions corresponding to one dose (e.g., in many cases, two actuations are needed per dose, corresponding to one actuation per nostril). Before ending 437, the robotic handler moves the collection vessel to the balance pan 432 and releases the collection vessel 434 so that it can be weighed by the balance 436.

In a process similar to process 400, a waste collector may be used instead of the collection vessel to perform pump delivery testing on a spray device using the delivered weighing mode (Table 4). Table 5 highlights basic example operations and functions of the robotic handler 120. It should be understood that the terms “pick up” and “release” are meant to convey the spirit of what the robotic handler may do, not how the robotic handler actually does it.

In a process similar to process 400, FIG. 4B is a flow diagram of an example process 400A of performing a dose content uniformity test on a spray device using the metered weighing mode (as described in Table 4). In a process similar to process 400A, a waste collector may be used instead of the collection vessel to perform pump delivery testing on a spray device using the metered weighing mode (as described in Table 4). Processess 400 and 400A may be combined into a new process 400B, as shown in FIG. 4C, to measure the dose content uniformity of a spray device using the delivered and metered weighing modes (as described in Table 4). In a process similar to 400B, a waste collector may be used instead of the collection vessel to perform pump delivery testing on a spray device using the delivered and metered weighing modes (as described in Table 4).

TABLE 5
Basic Example Operations and Functions of the Robotic Handler(s)

| | Start Position | | End Position | | Intermediate |
|---|---|---|---|---|---|
| | Location | Action(s) | Location | Action(s) | Action(s) |
| Devices | Device Holding | Pick up device | Actuator | Secure device in | None |
| | Area | | | actuator | |
| | | | | Release device | |
| | Actuator | Release device in | Device Holding | Release device | None |
| | | actuator | Area | | |
| | | Pick up device | | | |
| | Device Holding | Pick up device | Actuator | Secure device in | Shake according |
| | Area | | | actuator | to method |
| | | | | Release device | |
| | Actuator | Release device | Actuator | Secure device in | Shake according |
| | | from actuator | | actuator | to method |
| | | Pick up device | | Release device | |
| Collection | Collection vessel | Pick up | Balance pan | Release | Weigh collection |
| Vessels | Holding Area | collection vessel | | collection vessel | vessel |
| | Balance pan | Pick up | Over nozzle tip in | Hold collection | None |
| | | collection vessel | actuator | vessel | |
| | Over nozzle tip in | None (already | Balance pan | Release | Weigh collection |
| | actuator | being held) | | collection vessel | vessel |
| | Balance pan | Pick up | Collection vessel | Release | None |
| | | collection vessel | Holding Area | collection vessel | |
| WC | Waste collector | Pick up waste | Over nozzle tip in | Hold waste | None |
| | Holding Area | collector | actuator | collector | |
| | Over nozzle tip in | None (already | Waste collector | Release waste | None |
| | actuator | being held) | Holding Area | collector | |
| Tip | Tip dabber | Pick up tip | Over nozzle tip in | Dab nozzle tip | None |
| Dabber | holding area | dabber | actuator | | |
| | Over nozzle tip in | None (already | Tip dabber | Release tip | None |
| | actuator | being held) | Holding Area | dabber | |

Embodiments of the system 100 may provide various actuation measurement modes. In a priming mode, the system computer 114 may record in the database 115 the force and position versus time profiles acquired from the actuator. In a delivered or metered shot weight with individual tare mode, the system 100 weighs each shot based on taring the balance 255 after each actuation. In both modes, waste collectors 213 collect each shot according to a given test method. For delivered shot weight measurements the waste collector is weighed and for metered shot weight measurements the device is weighed. In a dose content uniformity mode, the system 100 collects individual doses in an appropriately sized collection vessel (e.g., a standard laboratory collection tube), and records the shot weight by measuring the weight differential of the collection vessel before and after actuation (i.e., the delivered shot weight method).

The system 100 described above is able to match at least the performance of a trained laboratory technician on a per-shot basis. Based on test runs of the system 100, including nozzle tip dabbing and balance taring after each actuation, a trained laboratory technician can collect, on average, approximately 50 delivered shot weight measurements in 25 minutes (or one measurement every 30 seconds on average) using a Mettler-Toledo AX-204 4-place analytical balance. Embodiments of the system 100 are designed not to allow any misreads of shot weight to occur due to machine malfunctions under normal operating conditions.

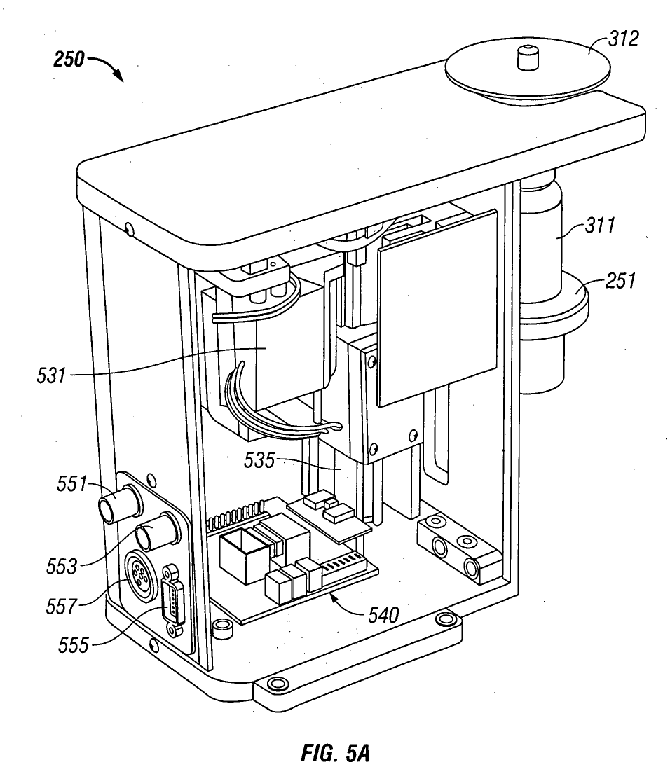

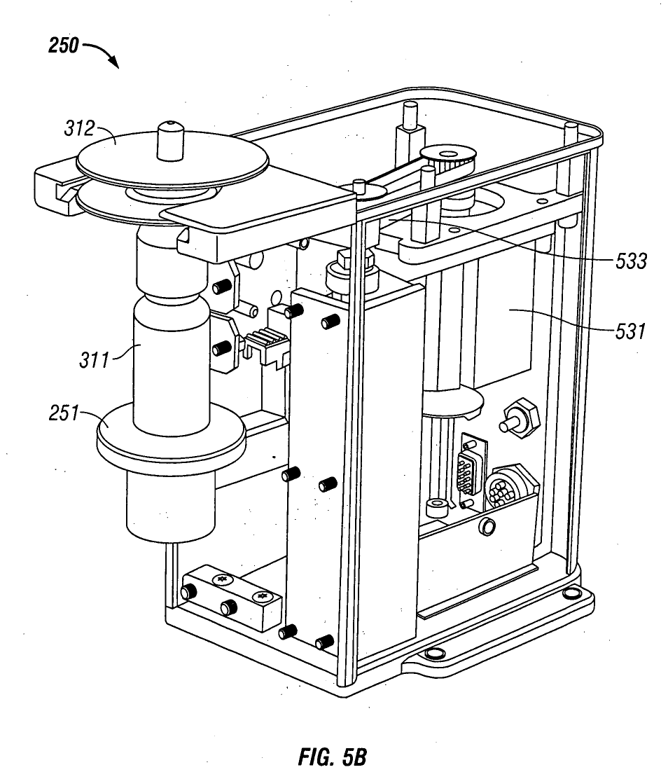

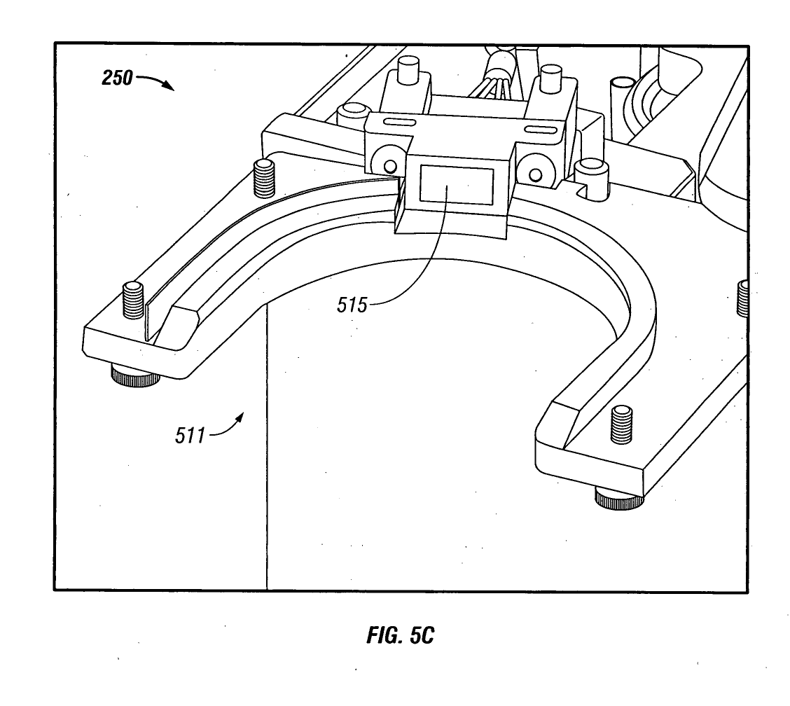

FIGS. 5A-5C are perspective views of an embodiment of the actuator 250 showing internal components according to one embodiment. This embodiment of the actuator 250 includes a rotary motor 531, a drive transmission component 535 (referred to above as a “linear screw-rail assembly”), a force coupler 251, and actuator electronics 540. The force coupler 251 may also include a force transducer in electrical communication with the actuator electronics 540. The drive coupler 533 includes two pulleys and a drive belt. One of the pulleys is attached to the rotary drive output of the rotary motor 531 (i.e., the motor spindle) so that the pulley rotates with the motor spindle. The other pulley is attached to a linear screw-rail spindle 532 of the linear screw-rail assembly 535 so that the pulley rotates with the screw rail spindle 532. The drive belt couples the two pulleys so that they rotate synchronously.

The force coupler 251 is coupled to the linear screw-rail assembly 535 such that the motor 531 may drive the screw rail spindle 532, which, in turn, drives the force coupler 251 to actuate the spray bottle 311. The actuator electronics 540 communicate with the system computer 114 and system controller 117 via connectors 551-555. For example, the actuator electronics 540 may receive commands from the system computer 114 to apply a specified force to actuate the spray bottle 311. The actuator 250 also includes a power connector 557 through which to provide power to the actuator electronics 540, the motor 531, and other components of the actuator 250.

The actuator 250 includes a receiver 511 for receiving and securing the collet 312 to the actuator 250. The actuator 250 may further include a sensor 515 for sensing the presence of the collet 312. The sensor may include a photoelectric sensor, magnetic sensor, or any other sensor for detecting the presence of the collet 312. The sensor 515 may communicate sensor signals through the sensor electronics 540 to the system computer 114. The receiver 511 may be spring-loaded to firmly secure the spray device in place during actuation.

As illustrated in FIGS. 5A-5C, the actuator 250 is configured for upward compression action of a traditional nasal spray pump with a vertically oriented spray plume. Other embodiments of the actuator 250 may include the same inner components described above (e.g., the drive mechanism), but may be configured for sideward or upward compression action of spray devices with either a horizontally or vertically oriented spray plume.

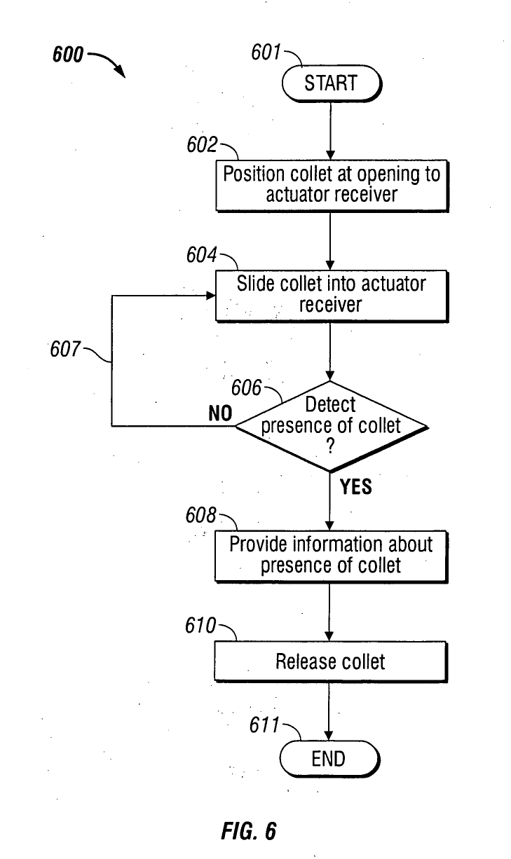

FIG. 6 is a flow diagram of an example process 600 of securing a spray pump device in an actuator. After starting 601, the robotic handler positions a collet at the opening to the actuator receiver 602 and slides the collet into the actuator receiver 604. If a receiver sensor detects the presence of the collet, the actuator electronics provides information about the presence of the collet 608 to a system computer. If the receiver sensor does not detect the presence of the collet 607, the robotic handler attempts once again to slide the collet into the actuator receiver 604. Before ending 611, the robotic handler releases the collet 610 so that the robotic handler, for example, may proceed to obtain a collection vessel or waste collector for DCU testing.

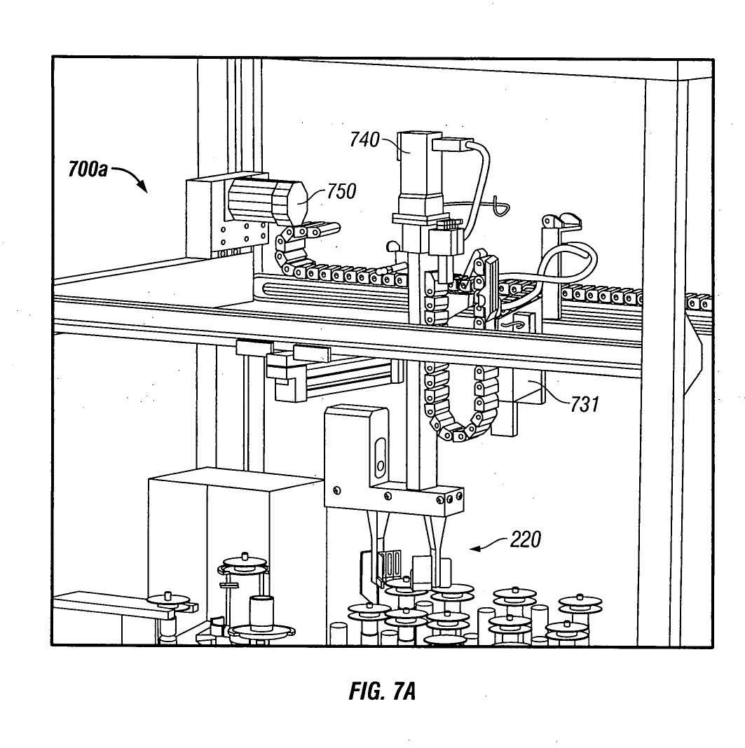

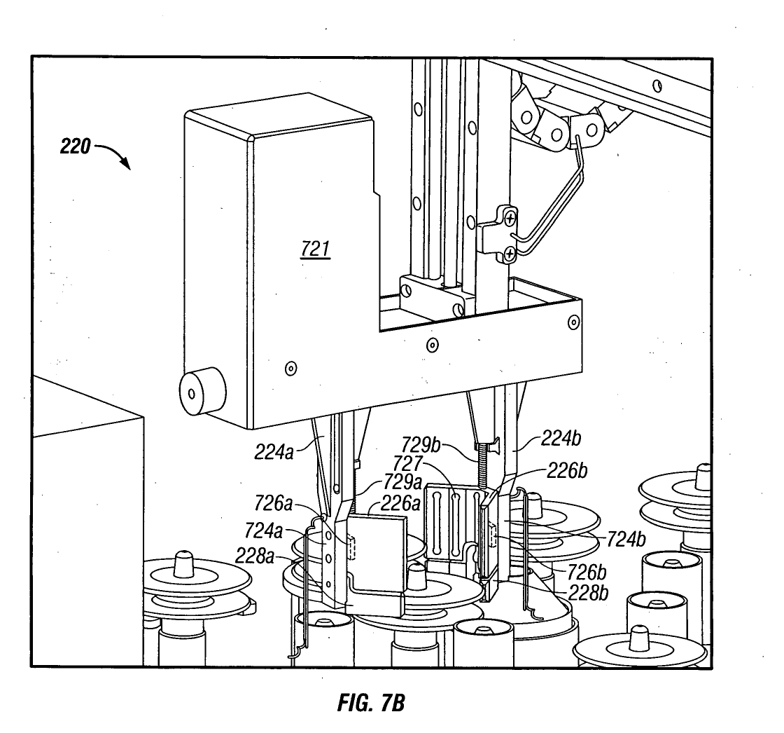

FIG. 7A-7B are perspective views of another embodiment of a robotic handler 700a. As with the robotic handler illustrated in FIGS. 2A-2B the robotic handler 220 includes motor assemblies 731, 740, and 750 and corresponding linear screw-rail assemblies to move the electromechanical gripper 220 in three dimensions.

The electromechanical gripper 220 includes a motor and linear screw-rail assembly 721 that drives first and second gripper elements 224a-b to grasp or release a spray device, collection vessel, or a waste collector. Each gripper element 224a-b includes movable jaws 226a-b, stationary jaws 228a-b, springs 729a-b, magnetic sensors 724a-b, and magnets 726a-b. The upper jaws 226a-b and springs 729a-b together are movably coupled to the gripper elements 224a-b to provide vertical compliance when, for example, a nozzle tip dabber held by the upper jaws 226a-b is being used to dab a spray device having a nozzle tip with an unknown height.

The magnetic sensors 724a-b are fixably mounted in respective gripper elements 224a-b and magnets 726a-b are mounted in respective upper jaws 226a-b. When the sensors 724a-b and corresponding magnets 726a-b misalign, the magnetic sensors 724a-b indicate to the system computer (e.g., system computer 114) that the object, such as a waste collector, has made contact with another object, such as a spray device. The magnetic sensors 724a-b may also provide information about the position of the upper jaws 226a-b relative to the gripper elements 224a-b.

As illustrated in FIG. 2A, the gripper elements 224a-b couple to a linear screw-rail assembly 222 that is driven by a rotary motor 221. The linear screw-rail assembly 222 includes a linear screw that includes left-handed and right-handed portions. Such a linear screw causes the gripper elements 224a-b to move synchronously in opposite directions when the rotary motor 221 drives the linear screw-rail assembly 222. In contrast, prior art pneumatic grippers only assume two positions: fully open or fully closed. The electromagnetic gripper 220, on the other hand, provides a full range of motion that is limited only by the full length of the linear screw. As a result, then electromechanical gripper may handle spray devices, collection vessels, or waste collectors, of various shapes and sizes.

The upper jaws 226a-b include V-grooves to allow the electromechanical gripper to firmly and securely grasp various objects. In this embodiment, the jaws 226a-b and 228a-b are designed with a V-shape with a predefined angle to further improve the electromechanical gripper's ability to grasp spray devices and other objects.

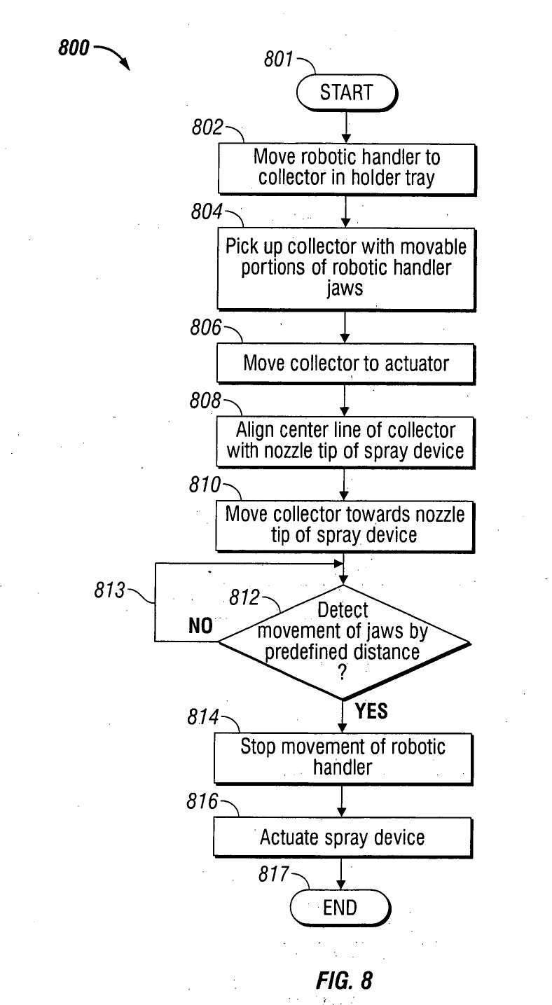

FIG. 8 is a flow diagram of an example process 800 of controlling the robotic handler based on feedback from sensors in the movable jaws of the electromechanical gripper. After starting 801, the system computer 114 issues commands to move the robotic handler to a collector in a holder tray 802. In step 804, the robotic handler picks up the collector with the movable portions of the robotic handler jaws and, in step 806, moves the collector to the actuator in which a spray device has been previously secured. The robotic handler then aligns the center line of the collector with the nozzle tip of the spray device 808. In step 810, the robotic handler moves the collector towards the nozzle tip of the spray device. When the jaw sensors detect movement of the jaws by a predefined distance 812, 813, the movement of the robotic handler is stopped 814. With the collector in place, the spray device is actuated 816 and the process 800 ends 817.

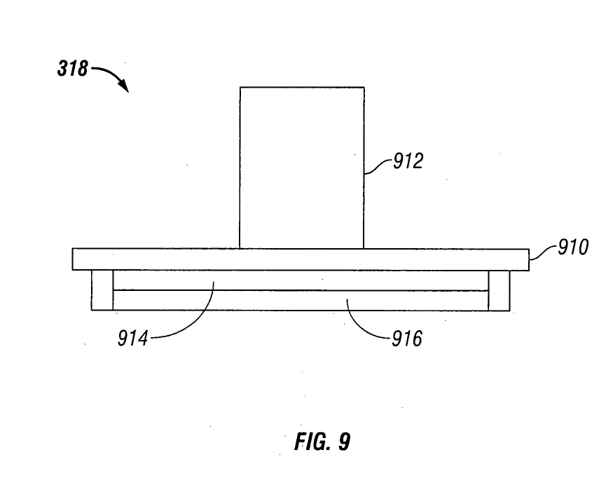

FIG. 9 is a cross sectional view of an example nozzle tip dabber 318 according to one embodiment. Preliminary analysis proved that only mechanical dabbing works effectively with thixotropic nasal spray formulations, especially those formulations containing sticking agents. Simple experiments show that air blowing or suction techniques only thinned out the formulation to a film due to a drop in viscosity and maintained the total mass of the spray device nearly constant (i.e., the residue remained on the nozzle tip in the form of a thin film rather than a droplet). The nozzle tip dabber 318 includes a base 910, handle 912, dabbing media 916, and a compliant background media 914 (e.g., a spongy media). The compliant background media 914 may attach to the base 910 and the dabbing media 916 using known techniques (e.g., using an adhesive). In one embodiment, the dabbing media 916 is a closed cell media so that spray device formulation does not distribute across the dabbing media 916. The closed cell dabbing media 916 allows the robotic handler to reuse the dabbing media 916 by using different areas of the dabbing media 916. The spongy background media 914 has been shown to improve the cleaning capabilities of the dabbing media 916.

An advantage of the nozzle tip dabber 318 is that it does not affect the performance of the spray device or otherwise alter the shot weight of the sprays. The nozzle tip dabber may be used to clean the nozzle tip area after each shot in the worst case scenario or after an actuation group in a minimal scenario.

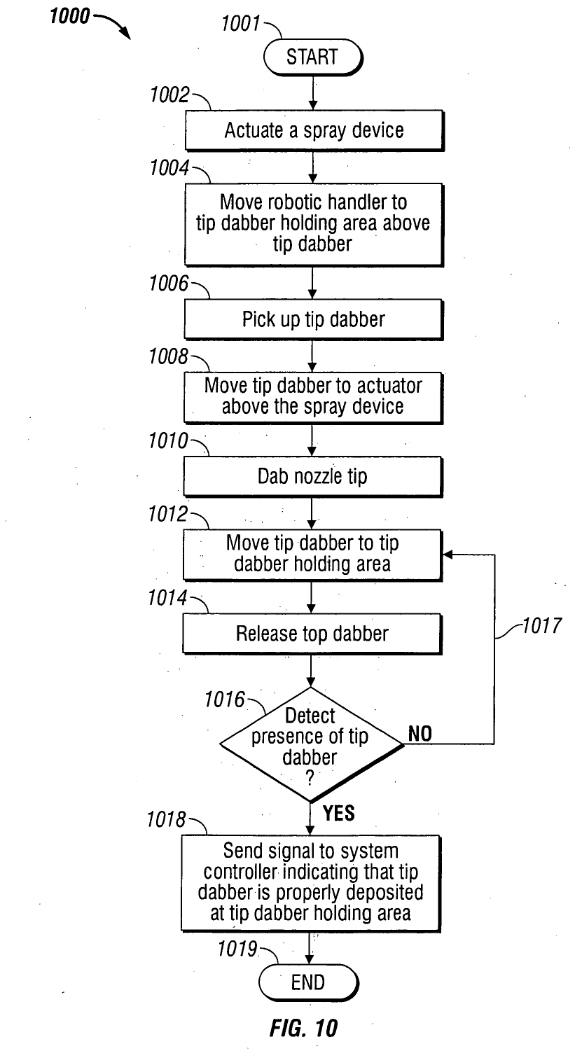

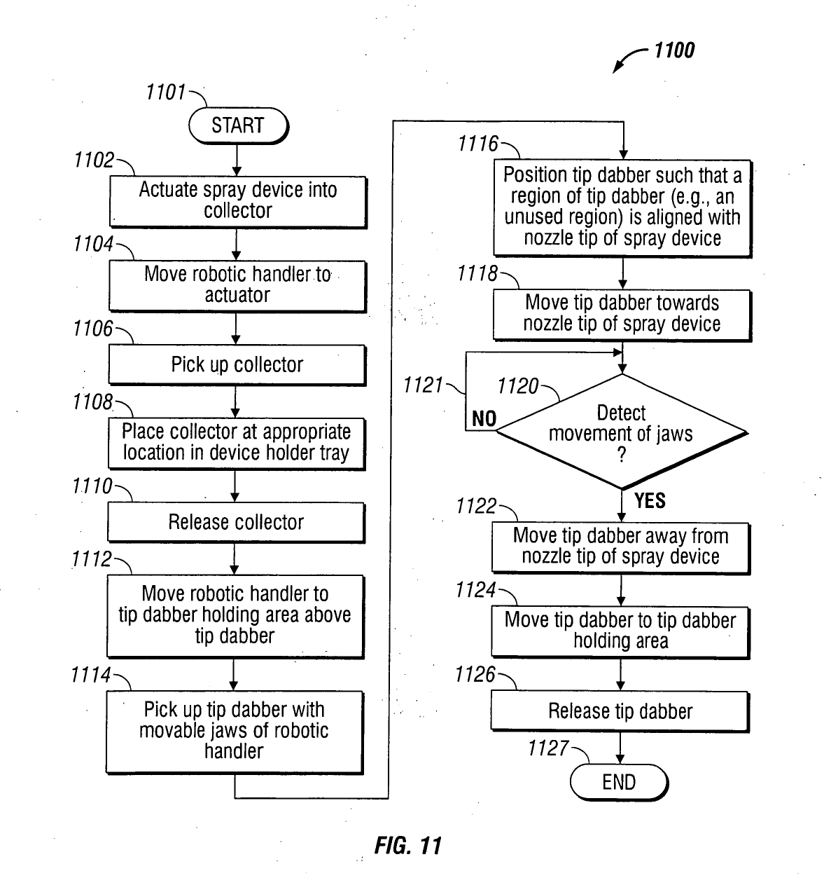

FIGS. 10-11 are flow diagrams of example processes 1000, 1100 for testing a spray pump device illustrating use of an embodiment of the nozzle tip dabber of FIG. 9. After starting 1001 process 1000, the system computer 114 issues a command to the actuator to actuate a spray device 1002. In step 1004, the robotic handler is commanded to move to the tip dabber holding area and, in step 1006, to pick up the tip dabber. In step 1008, the robotic handler moves the tip dabber to the actuator above the spray device and, in step 1010, dabs the spray device nozzle tip with the tip dabber. The robotic handler then moves the tip dabber to the tip dabber holding area 1012 and releases the tip dabber 1014. Before ending 1019, if the tip dabber sensor 319 (FIG. 3) detects the presence of the tip dabber 1016, the sensor sends a signal to the system computer that the tip dabber has been properly deposited at the tip dabber holding area. Otherwise 1017, the robotic handler moves the tip dabber to the tip dabber holding area 1012 and releases the tip dabber 1014 until the tip dabber sensor 319 detects the presence of the tip dabber 1016.

After process 1100 starts 1101, the actuator actuates a spray device into a collector 1102, such as a collection vessel. In steps 1104-1110 the robotic handler moves to the actuator 1104, picks up the collector 1106, places the collector at the appropriate location in the device holder tray 1108, and releases the collector 1110. In step 1112, the robotic handler moves to the tip dabber holding area and, in step 1114, picks up the tip dabber with the movable jaws of the robotic handler.

In step 1116, the robotic handler moves the tip dabber to the actuator and positions the tip dabber such that an area of the tip dabber (e.g., an unused area) is aligned with the nozzle tip of the spray device. In step 1118, the robotic handler moves the tip dabber towards the nozzle tip of the spray device. If the robotic handler detects movement of the movable jaws 1120-1121, indicating that the tip dabber has made contact with the nozzle tip of the spray device, the robotic handler moves the tip dabber away from the nozzle tip of the device 1122. Alternatively, the robotic handler may not move the tip dabber away from the nozzle tip of the device, but stop the robotic handler so that the tip dabber maintains contact with the nozzle tip of the spray device for a given period of time. Before ending 1127, the robotic handler moves the tip dabber to the tip dabber holding area 1124 and releases the tip dabber 1126.

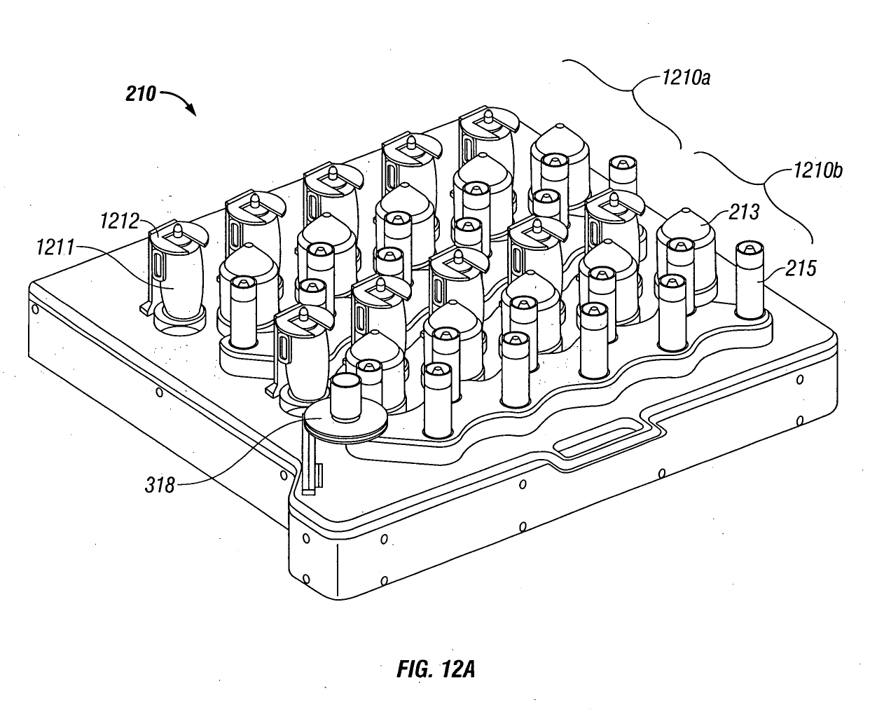

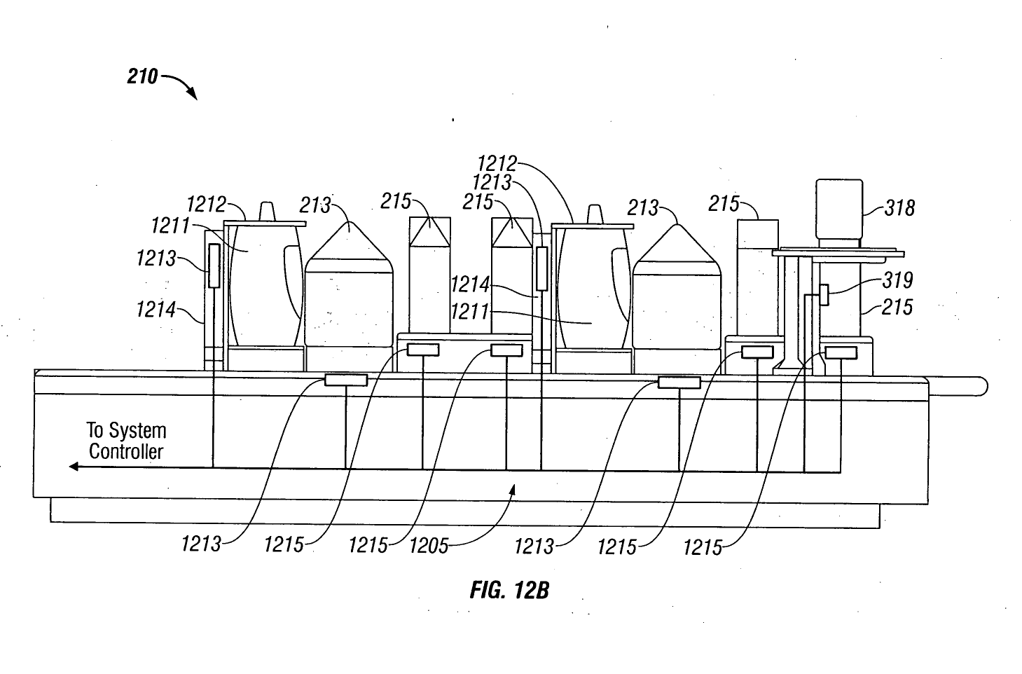

FIG. 12A is a perspective view of a fully loaded holder tray 210 according to one embodiment. In this embodiment, there are two rows 1210a-b of side actuated spray devices 1211 and corresponding spray device holders 1212, waste collectors 213, and collection vessels 215. Each row 1210a-b includes five spray devices 1211, five waste collectors 213, and ten collection vessels 215. Ten spray device samples are considered by most manufacturers and the USP to be representative of one batch's performance and, hence, is the form factor of this embodiment of the system for dose content uniformity testing. Preliminary design analysis proved that attempting to handle more devices could not be justified from a cost-benefit perspective in a typical pharmaceutical production environment. However, in other embodiments, more spray devices may be handled for pump delivery testing.

According to one estimate, the maximum fluid capacity of currently marketed nasal spray products is approximately 40 mL. Therefore, this embodiment of the system is capable of handling a maximum of 400 mL (40 mL×10 spray devices 1211) of fluid in one run in a dose content uniformity test and 800 mL (40 mL×20 spray devices 1211) in a pump delivery test. The system is also capable of handling identical spray devices from the same or different batches.

FIG. 12B is a side view of the holder tray of FIG. 12A illustrating a holder tray sensor system 1205 according to one embodiment. The holder tray sensor system 1205 includes sensors 1213-1215 associated with respective waste collectors 213, spray devices 1211, and collection vessels 215. Sensors 1213 associated with spray devices 1211 may be mounted in spray device receivers 1214 and configured to sense the presence of the spray device holder 1212. The sensors 1213-1215 may be photoelectric sensors, magnetic sensors, mechanical-type sensors, and so forth, for sensing the presence or absence of the corresponding spray device 1211, waste collector 213, or collection vessel 215. The sensors 1213-1215 may send sensor signals to the system computer to indicate either the presence or absence of a spray device 1211, waste collector 213, or collection vessel 215. The system computer may, in turn, provide a visual indication to the user as to which elements (e.g., spray device, waste collector, or collection vessel) need to be inserted and where they should be inserted.

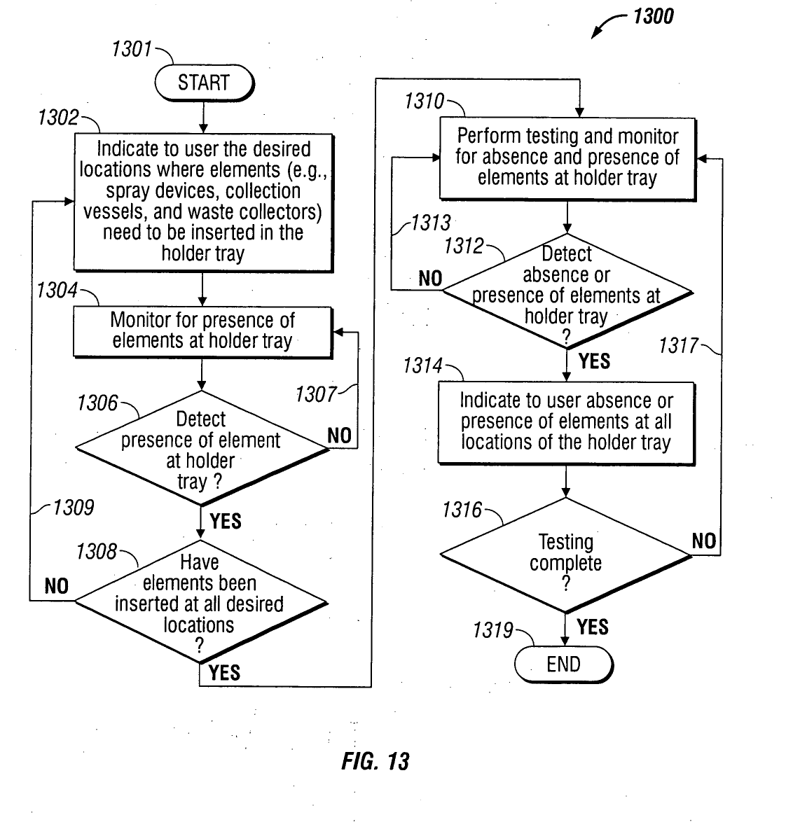

FIG. 13 is a flow diagram of an example process 1300 illustrating use of the holder tray sensor system 1205 of FIG. 12B. After starting 1301, the system computer indicates to a user through an I/O device the desired locations where elements (e.g., spray devices, collection vessels, and waste collectors) need to be inserted in the holder tray 1302. In step 1304, sensors monitor for the presence of the elements at the holder tray. If a sensor or group of sensors detect the presence of element(s) at the holder tray 1306, the system computer determines whether elements have been inserted at all the desired locations 1308. If elements have not been inserted at all desired locations 1309, the system computer indicates to the user the desired locations where elements need to be inserted in the holder tray 1302. Otherwise, the system computer proceeds to perform testing and monitors for the absence or presence of elements at the holder tray 1310.

If the holder tray sensors detect the absence or presence of elements at the holder tray 1312, the system computer indicates to the user the absence or presence of elements at all locations of the holder tray 1314. Until the testing is complete 1316, 1317, the system computer continues to monitor for the absence and presence of elements at the holder tray 1310. In step 1319, the process 1300 ends.

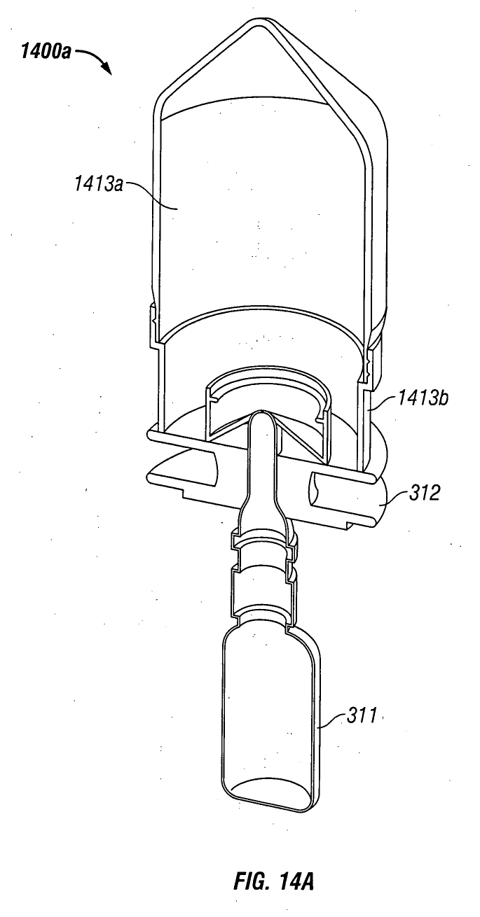

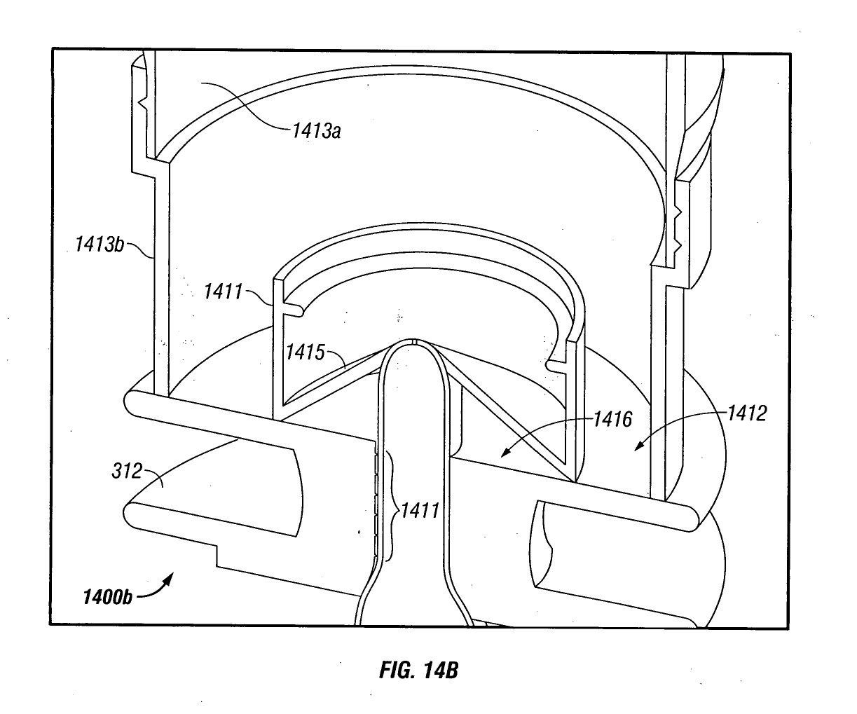

FIGS. 14A-14B are perspective cross-sectional views of spray pump collection assemblies 1400a-b according to one embodiment. The spray pump collection assemblies 1400a-b include a spray pump bottle 311, collet 312, collection vessel base 1413b and collection vessel top 1413a. The collection vessel top 1314a and collection vessel base 1413b include threads for screwing together the collection vessel top 1413a and collection vessel base 1413b.

The collection vessel base 1413b includes a first inner wall 1411 to provide a first collection area 1412 and a second inner wall 1415 to provide a second collection area 1416 between the first and second inner walls 1411, 1415. The second inner wall 1415 and the second collection area 1416 may compose a “plug” that is inserted into the collection vessel base 1413b. The first collection area 1412 collects the majority of formulations that are ejected from the spray bottle 311. The remaining formulation that is not collected in the second collection area 1412 is collected in the second collection area 1416.

The spray pump collection assemblies 1400a-b include collets 312. The collet 312 has an aperture with threads 1411. The aperture of the collet 312 is tapered such that the threads 1411 of the aperture grip the spray bottle's nozzle tip as the collet 312 is screwed onto the spray bottle's nozzle tip. The collet 312 does not effect the spraying function of the spray bottle 311 because the threads 1411 of the aperture grasp the base of the spray bottle nozzle tip. The collet 312 facilitates easy handling of the spray bottle 311, for example, by a robotic handler or an actuator.

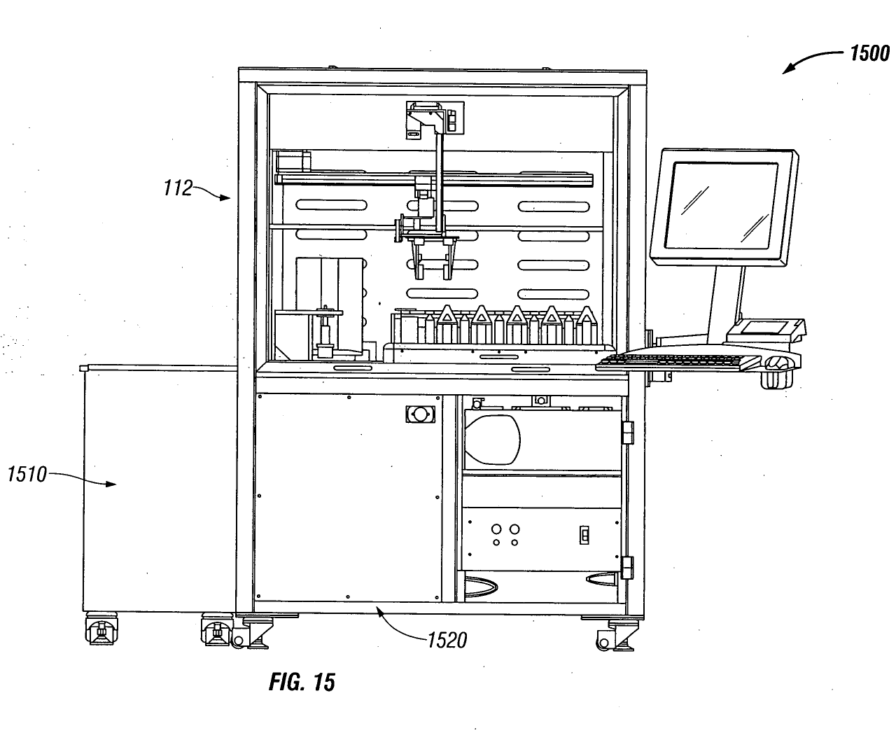

FIG. 15 is a front view of an embodiment of an automated spray pump testing system 1500 for DCU, pump delivery, spray pattern, and droplet size distribution testing. In addition to the DCU and pump delivery testing area 112, the automated spray pump testing system 1500 includes an integrated optical measurement volume 1520 and an extension volume 1510 for optical measurement devices.

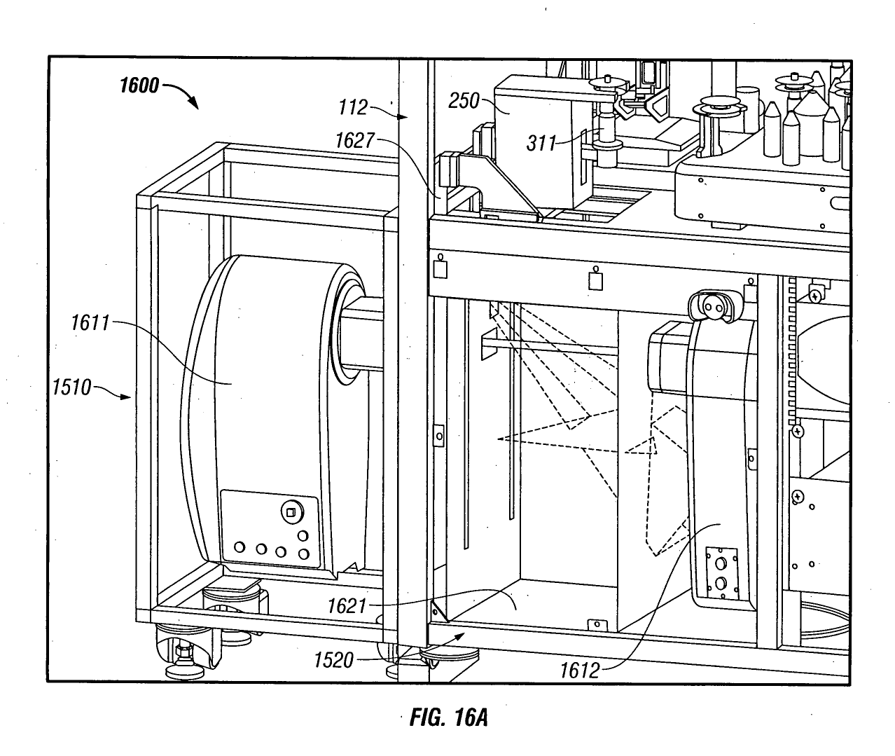

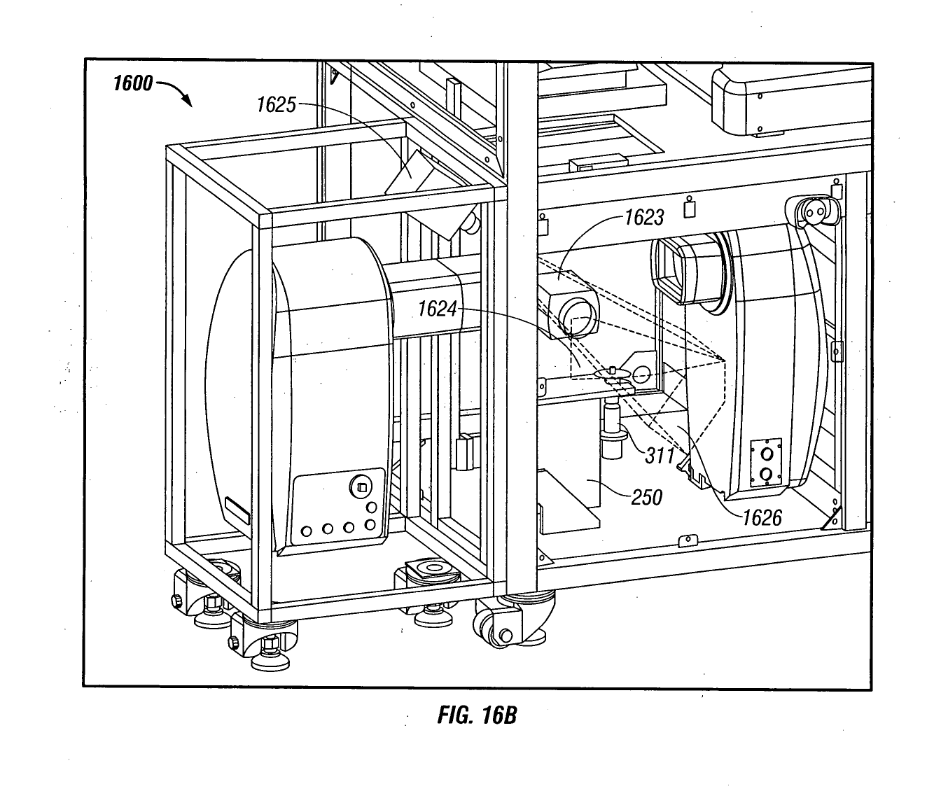

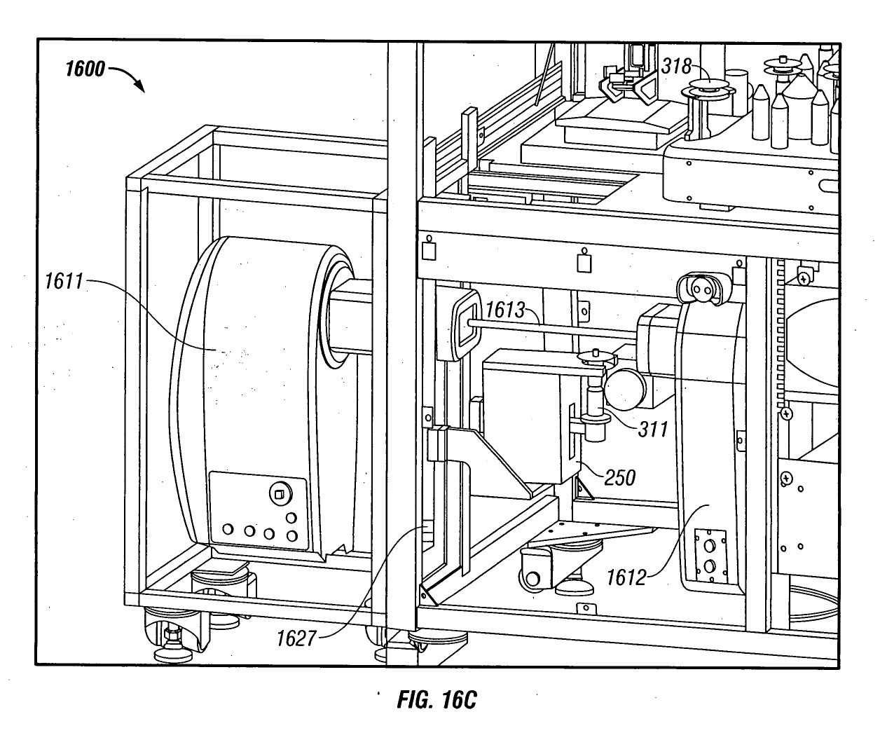

FIG. 16A is a perspective view of the optical measurement volume and the optical device extension volume 1600 for spray pattern and droplet size distribution testing. As illustrated in FIG. 16A, the optical measurement volume 1520 includes an isolated enclosure 1621 in which to perform spray pattern and droplet size distribution measurements. The enclosure 1621 provides a way of containing the formulations ejected from spray bottles in spray pattern and droplet size distribution measurements. For droplet size distribution measurements, the optical measurement volume includes a laser 1612 and the extension volume 1510 includes the corresponding receiver 1611. The actuator 250 is coupled to an elevator assembly 1627 for transporting a spray bottle 311 from the DCU and pump delivery testing area 112 to the enclosure 1621 for spray pattern and droplet size distribution measurements. The elevator assembly 1627 allows for automatic nozzle tip to optical axis positioning. The spray enclosure allows for easy cleaning and protects the optical hardware.

FIG. 16B is a perspective view of the optical measurement volume and the optical device extension volume 1600 of FIG. 16A, illustrating spray pattern testing. For spray pattern testing, a laser 1623 emits a light sheet 1624 and a camera 1625 captures images in the camera's field of view 1626 when the actuator 250 actuates the spray bottle 311.

FIG. 16C is a perspective view of the optical measurement volume and optical device extension volume 1600 of FIG. 16A illustrating droplet size distribution testing. The elevator assembly 1627 positions the nozzle tip of the spray bottle 311 to provide the desired distance between the nozzle tip and the optical axis of the laser beam 1513 emitted from the laser 1612 and received by the receiver 1611.

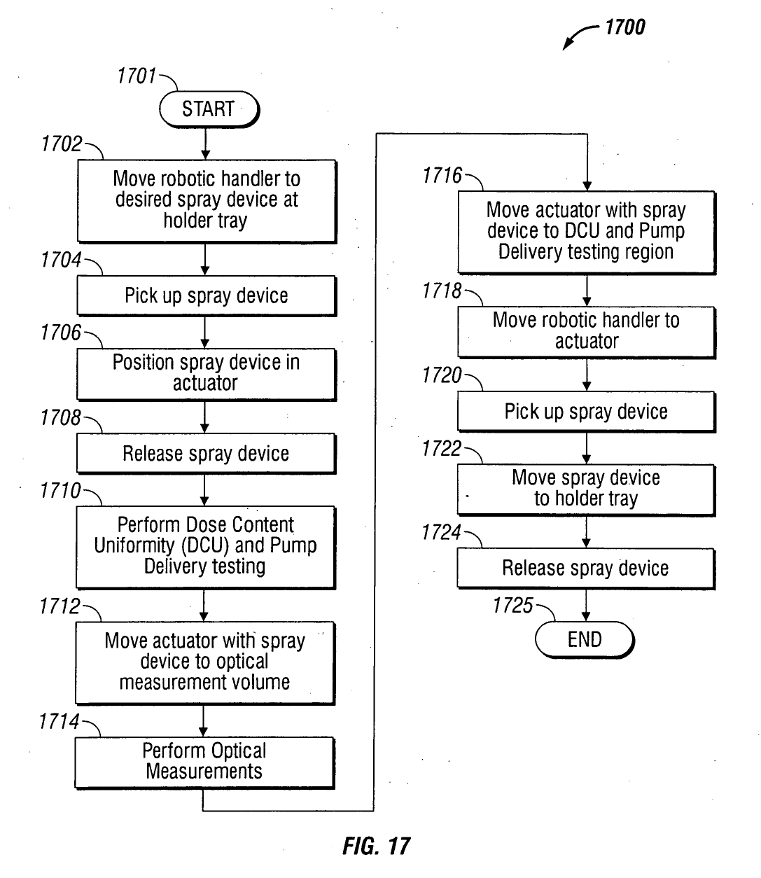

FIG. 17 is a flow diagram of a process 1700 of testing a spray pump device using the automated spray pump testing system of FIGS. 15 and 16A-16C. After starting 1701, the robotic handler moves to a desired spray device at the holder tray 1702 and picks up that spray device 1704. In step 1706, the robotic handler positions and secures the spray device in the actuator and, in step 1708, releases the spray device. In step 1710, dose content uniformity (DCU) and pump delivery testing are performed. Once DCU and pump delivery testing is complete, the actuator, along with the spray device, is moved to the optical measurement volume 1712 where optical measurements are performed 1714, such as spray pattern and droplet size distribution measurements.

After performing optical measurements 1714, the actuator, along with the spray device, return to the DCU and pump delivery testing region 1716. Before ending 1725, the robotic handler moves to the actuator 1718, picks up the spray device 1720, moves the spray device to the holder tray 1722, and releases the spray device 1724.

While this invention has been particularly shown and described with references to example embodiments thereof, it will be understood by those skilled in the art that various changes in form and details may be made therein without departing from the scope of the invention encompassed by the appended claims.

It should be understood that any of the above-described flow diagrams of FIGS. 4A-4C, 6, 8, 10, 11, 13, and 17 may be implemented in the form of hardware, firmware, or software. If implemented in software, the software may be in any suitable form of software that can be stored on any form of machine-readable medium (e.g., CD-ROM), and loaded and executed by at least one general purpose or application specific processor.

What is claimed is:

1. A system for testing spray pump assemblies, the system comprising:
a spray pump assembly actuator for actuating individual spray pump assemblies under test;
one or more trays configured to hold multiple spray pump assemblies or collectors or both;
a weighing device configured to weigh spray pump assemblies or collectors or both;
a robotic handler configured to transport the spray pump assemblies or collectors or both between the actuator, weighing device and tray; and
a system computer configured to communicate control and sensing signals between the spray pump actuator, weighing device, tray and robotic handler for testing the spray pump assemblies.

2. The system according to claim 1, wherein the system computer is configured to perform spray pump delivery or spray content uniformity tests or both.

3. The system according to claim 1, wherein the system computer is configured to calculate a delivered dose weight amount by controlling the spray pump actuator, weighing device and robotic handler to weigh a particular collector before and after actuation of a corresponding spray pump assembly under test.

4. The system of claim 1, wherein the system computer is configured to calculate a metered dose weight amount by controlling the spray pump actuator, weighing device and robotic handler to weigh a particular spray pump assembly under test before and after actuation.

5. The system according to claim 1, wherein the system computer is configured to (a) calculate a delivered dose weight amount by controlling the spray pump actuator, weighing device and robotic handler to weigh a particular collector before and after actuation of a corresponding spray pump assembly under test and (b) calculate a metered dose weight amount by controlling the spray pump actuator, weighing device and robotic handler to weigh a particular spray pump assembly under test before and after actuation.

6. The system according to claim 1, wherein the robotic handler includes an electromechanical gripper, the electromechanical gripper including:
a rotary motor;
a linear screw coupled to the rotary motor, the linear screw having right-handed threads on a first end of the linear screw and left-handed threads on a second end of the linear screw;
a first gripper component coupled to the first end of the linear screw, the first gripper component configured to move in a first direction when the rotary motor rotates the linear screw in a second direction;
a second gripper component coupled to the second end of the linear screw, the second gripper component configured to move in a third direction opposite from the first direction when the rotary motor rotates the linear screw in the second direction.

7. The system according to claim 6, wherein the electromechanical gripper further includes individual jaws movably coupled to respective gripper elements, the gripper elements including sensors configured to sense movement of the jaws.

8. The system according to claim 1, further including a spray pump holder component including a clamp having an aperture disposed about a central axis, the aperture having a first diameter at a bottom side of the clamp and a second diameter at a top side of the clamp, the aperture having threads, wherein a spray pump nozzle component is inserted into the aperture along the central axis and the clamp is rotated in a direction so as to secure the spray pump nozzle component to the clamp.

9. The system according to claim 1, further including a nozzle tip dabber that includes a base, an absorbent pad, and a spongy pad, the spongy pad disposed between the absorbent pad and the nozzle tip dabber.

10. The system according to claim 1, wherein the tray includes sensors associated with each spray pump assembly to sense the presence of each spray pump assembly.

11. A system for testing a spray pump assembly, the system comprising:
a first testing region including a first testing device configured to perform a first test on a spray pump assembly;
a second testing region coupled to the first testing region, the second testing region including a second testing device configured to perform a second test on the spray pump assembly; and
a spray pump assembly actuator coupled to an elevator assembly, the elevator assembly configured to move the actuator between the first and second measurement regions.

12. The system according to claim 11, wherein the first testing region includes a robotic handler for handling and transporting the spray pump assembly.

13. The system according to claim 11, wherein the first testing device is a weighing device and the second testing device includes either (i) a camera and a first laser configured to measure spray pattern, or (ii) a second laser and a receiver configured to measure droplet size distribution through laser diffraction, or both.

14. A method of testing a spray pump assembly, the method comprising:
performing a first test on a spray pump assembly at a first test region with a first testing device; and
performing a second test on the spray pump assembly at a second test region with a second testing device.

15. The method of claim 14, wherein the first testing device is a weighing device and the second testing device includes either (i) a camera and a first laser configured to measure spray pattern, or (ii) a second laser and a receiver configured to measure droplet size distribution through laser diffraction, or both.
